(19) United States
(12) Patent Application Publication
(10) Pub. No.: US 2010/0266907 A1
(43) Pub. Date: Oct. 21, 2010

(54) METAL AIR BATTERY SYSTEM

(76) Inventor: Rachid YAZAMI, Los Angeles, CA (US)

Correspondence Address: GREENLEE SULLIVAN P.C., 4875 PEARL EAST CIRCLE, SUITE 200, BOULDER, CO, 80301, US

(21) Appl. No.: 12/766,224

(22) Filed: Apr. 23, 2010

Related U.S. Application Data
(63) Continuation-in-part of application No. PCT/US2009/063235, filed on Nov. 4, 2009.
Application No. PCT/US2009/063235 is a continuation-in-part of application No. 12/612,409, filed on Nov. 4, 2009.
(60) Provisional application No. 61/247,882, filed on Oct. 1, 2009.
(60) Provisional application No. 61/172,114, filed on Apr. 23, 2009.
(60) Provisional application No. 61/198,237, filed on Nov. 4, 2008.
(60) Provisional application No. 61/247,882, filed on Oct. 1, 2009.
(60) Provisional application No. 61/198,237, filed on Nov. 4, 2008.
(60) Provisional application No. 61/247,882, filed on Oct. 1, 2009.

(51) Int. Cl. H01M 8/22; H02J 7/04; H02J 7/00

(52) U.S. Cl. 429/405; 320/162; 320/128

(57) ABSTRACT

Described herein are electrodes comprising a fluorinated or metalloprotein oxygen dissolution enhancer provided in a solvent for enhancing dissolution of oxygen in the solvent. In related embodiments, a metal oxide dissolution enhancer is provided in the solvent for enhancing dissolution of metal oxide formed via reaction of oxygen with metal ions in the solvent. The oxygen and metal oxide dissolution enhancers of electrodes and electrochemical generators described herein enable an increased oxidation and/or reduction rate and enhance the stability and efficiency of the electrochemical generators described herein. Positive electrodes described herein, for example, are highly versatile and compatible with a wide range of solid state and liquid anode and electrolyte systems, including anodes comprising readily available and inexpensive materials such as solvated electron solutions as well as a range of solid state anodes.

### CROSS REFERENCE TO RELATED APPLICATIONS

This application claims the benefit and priority of U.S. Provisional Application No. 61/247,882, filed Oct. 1, 2009 and U.S. Provisional Application No. 61/172,114, filed Apr. 23, 2009, which are each hereby incorporated by reference in their entireties to the extent not inconsistent with the present description. This application is a continuation-in-part of U.S. application Ser. No. 12/612,409, filed Nov. 4, 2009, and PCT International Application No. PCT/US2009/063235, filed Nov. 4, 2009, each of which is pending and each of which claims the benefit under 35 U.S.C. §119(e) of U.S. Provisional Application No. 61/198,237, filed Nov. 4, 2008, and U.S. Provisional Application No. 61/247,882, filed Oct. 1, 2009, which are each hereby incorporated by reference in their entireties to the extent not inconsistent with the present description.

### BACKGROUND

Over the last few decades revolutionary advances have been made in electrochemical storage and conversion devices expanding the capabilities of these systems in a variety of fields including portable electronic devices, air and space craft technologies, and biomedical instrumentation. Current state of the art electrochemical storage and conversion devices have designs and performance attributes that are specifically engineered to provide compatibility with a diverse range of application requirements and operating environments. For example, advanced electrochemical storage systems have been developed spanning the range from high energy density batteries exhibiting very low self discharge rates and high discharge reliability for implanted medical devices to inexpensive, light weight rechargeable batteries providing long runtimes for a wide range of portable electronic devices to high capacity batteries for military and aerospace applications capable of providing extremely high discharge rates over short time periods.

Despite the development and widespread adoption of this diverse suite of advanced electrochemical storage and conversion systems, significant pressure continues to stimulate research to expand the functionality of these systems, thereby enabling an even wider range of device applications. Large growth in the demand for high power portable electronic products, for example, has created enormous interest in developing safe, light weight primary and secondary batteries providing higher energy densities. In addition, the demand for miniaturization in the field of consumer electronics and instrumentation continues to stimulate research into novel design and material strategies for reducing the sizes, masses and form factors of high performance batteries. Further, continued development in the fields of electric vehicles and aerospace engineering has also created a need for mechanically robust, high reliability, high energy density and high power density batteries capable of good device performance in a useful range of operating environments.

Many recent advances in electrochemical storage and conversion technology are directly attributable to discovery and integration of new materials for battery components. Lithium battery technology, for example, continues to rapidly develop, at least in part, due to the discovery of novel electrode and electrolyte materials for these systems. From the pioneering discovery and optimization of intercalation host materials for positive electrodes, such as fluorinated carbon materials and nanostructured transition metal oxides, to the development of high performance non-aqueous electrolytes, the implementation of novel materials strategies for lithium battery systems have revolutionized their design and performance capabilities. Furthermore, development of intercalation host materials for negative electrodes has led to the discovery and commercial implementation of lithium ion based secondary batteries exhibiting high capacity, good stability and useful cycle life. As a result of these advances, lithium based battery technology is currently widely adopted for use in a range of important applications including primary and secondary electrochemical cells for portable electronic systems.

Commercial primary lithium battery systems typically utilize a lithium metal negative electrode for generating lithium ions which during discharge are transported through a liquid phase or solid phase electrolyte and undergo intercalation reaction at a positive electrode comprising an intercalation host material. Dual intercalation lithium ion secondary batteries have also been developed, wherein lithium metal is replaced with a lithium ion intercalation host material for the negative electrode, such as, carbons (e.g., graphite, cokes etc.), metal oxides, metal nitrides and metal phosphides. Simultaneous lithium ion insertion and de-insertion reactions allow lithium ions to migrate between the positive and negative intercalation electrodes during discharge and charging. Incorporation of a lithium ion intercalation host material for the negative electrode has the significant advantage of avoiding the use of metallic lithium which is susceptible to safety problems upon recharging attributable to the highly reactive nature and non-epitaxial deposition properties of lithium.

The element lithium has a unique combination of properties that make it attractive for use in an electrochemical cell. First, it is the lightest metal in the periodic table having an atomic mass of 6.94 AMU. Second, lithium has a very low electrochemical oxidation/reduction potential, i.e., −3.045 V vs. NHE (normal hydrogen reference electrode). This unique combination of properties enables lithium based electrochemical cells to have very high specific capacities. Advances in materials strategies and electrochemical cell designs for lithium battery technology have realized electrochemical cells capable of providing useful device performance including: (i) high cell voltages (e.g. up to about 3.8 V), (ii) substantially constant (e.g., flat) discharge profiles, (iii) long shelf-life (e.g., up to 10 years), and (iv) compatibility with a range of operating temperatures (e.g., −20 to 60 degrees Celsius). As a result of these beneficial characteristics, primary lithium batteries are widely used as power sources in a range of portable electronic devices and in other important device applications including, electronics, information technology, communication, biomedical engineering, sensing, military, and lighting.

State of the art lithium ion secondary batteries provide excellent charge-discharge characteristics, and thus, have also been widely adopted as power sources in portable electronic devices, such as cellular telephones and portable computers. U.S. Pat. Nos. 6,852,446, 6,306,540, 6,489,055, and “Lithium Batteries Science and Technology” edited by Gholam-Abbas Nazri and Gianfranco Pistoia, Kluer Academic Publishers, 2004, are directed to lithium and lithium ion battery systems which are hereby incorporated by reference in their entireties.

As noted above, lithium metal is extremely reactive, particularly with water and many organic solvents, and this attribute necessitates use of an intercalation host material for the negative electrode in traditional secondary lithium based electrochemical cells. Substantial research in this field has resulted in a range of useful intercalation host materials for these systems, such as LiC₆, LiₓSi, LiₓSn and Liₓ(CoSnTi). Use of an intercalation host material for the negative electrode, however, inevitably results in a cell voltage that is lower by an amount corresponding to the free energy of insertion/dissolution of lithium in the intercalation electrode. As a result, conventional state of the art dual intercalation lithium ion electrochemical cells are currently limited to providing average operating voltages less than or equal to about 4 Volts. This requirement on the composition of the negative electrode also results in substantial loss in the specific energies achievable in these systems. Further, incorporation of an intercalation host material for the negative electrode does not entirely eliminate safety risks. Charging these lithium ion battery systems, for example, must be carried out under very controlled conditions to avoid overcharging or heating that can result in decomposition of the positive electrode. Further, unwanted side reactions involving lithium ion can occur in these systems resulting in the formation of reactive metallic lithium that implicate significant safety concerns. During charging at high rates or at low temperatures, lithium deposition results in dendrides formation that may grow across the separator and cause an internal short-circuit within the cell, generating heat, pressure and possible fire from combustion of the organic electrolyte and reaction of metallic lithium with air oxygen and moisture.

Many battery technologies have been proposed for electric vehicles. The battery performance characteristics necessary for providing reasonable torque, power and range for electric vehicles are very different than those necessary for mobile electronics. The specific energy necessary to provide reasonable torque and power for an electric vehicle range of about 100 miles has been estimated to be about 100 Wh/kg. [C.-H. Dustmann, Battery Technology Handbook, Second Edition, Chapter 10, 2003.] Several battery technologies capable of providing this specific energy have been proposed for use with electric vehicles, some of which are summarized in Table B1, below. (Table reproduced from C.-H. Dustmann, Battery Technology Handbook, Second Edition, Chapter 10, 2003.) As can be seen from Table 1, the battery systems proposed for electric vehicles either do not meet the 100 Wh/kg specific energy minimum or are just above while, several of the operating temperature ranges for these battery technologies are elevated (e.g., Na/NiCl₂ and Na/S) or quite restricted (e.g., Li-polymer). Safety is also a major concern with respect to battery technology for electric vehicles and many of the candidate systems can lead to toxic gas evolution (e.g., Na/S), require significant protection of the active components (e.g., Na/NiCl₂) or have serious concerns with regard to crash safety (e.g., Li-ion). In addition, the cost of lithium has risen significantly with the adoption of Li-ion technology in the mobile handset and computing markets. Batteries based upon other technologies, therefore, are desirable for some applications, including electric vehicles which require much larger amounts of materials than mobile hand set batteries and mobile computer batteries.

TABLE B1
Proposed Electric Vehicle Battery Systems

| | | | | | | Li- |
|---|---|---|---|---|---|---|
| System | Pb/PbO | NiMH | Na/NiCl₂ | Na/S | Li-ion | polymer |
| Operating | <45 | <45 | 235-350 | 285-330 | <50 | 60-80 |
| Temperature | | | | | | |
| (° C.) | | | | | | |
| Electrolyte | H₂SO₄ | KOH | β″- | β″- | LiPF₆ | Poly- |
| | | | ceramic | ceramic | | ethylene |
| | | | | | | Oxide |
| Cell OCV | 2.0 | 1.2 | 2.58 | 2.1 | 4.0 | 4.0 |
| (V) | | | | | | |
| Specific | 25-35 | 40-60 | 100-120 | 110 | 80-120 | 100-120 |
| Energy | | | | | | |
| (Wh/kg) | | | | | | |
| Energy | 50-90 | 120-160 | 160-200 | 135 | 200 | 200 |
| Density | | | | | | |
| (Wh/L) | | | | | | |
| Specific | 150 | Up to | 150-180 | <75 | 500-800 | 300-400 |
| Power | | 1000 | | | | |
| (W/kg) | | | | | | |

A battery consists of a positive electrode (cathode during discharge), a negative electrode (anode during discharge) and an electrolyte. The electrolyte can contain ionic species that are the charge carriers. Electrolytes in batteries can be of several different types: (1) pure cation conductors (e.g., beta Alumina conducts with Na⁺ only); (2) pure anion conductors (e.g., high temperature ceramics conduct with O⁻ or O²⁻ anions only); and (3) mixed ionic conductors (e.g., some Alkaline batteries use a KOH aqueous solution that conducts with both OH⁻ and K⁺, whereas some lithium ion batteries use an organic solution of LiPF₆ that conducts with both Li⁺ and PF₆⁻). During charge and discharge electrodes exchange ions with electrolyte and electrons with an external circuit (a load or a charger).

There are two types of electrode reactions.
1. Cation based electrode reactions: In these reactions, the electrode captures or releases a cation r from electrolyte and an electron from the external circuit:

Electrode+Y⁺+e⁻→Electrode(Y).

Examples of cation based electrode reactions include: (i) carbon anode in a lithium ion battery: 6C+Li⁺+e⁻→LiC₆ (charge); (ii) lithium cobalt oxide cathode in a lithium ion battery: 2Li_{0.5}CoO₂+Li⁺+e⁻→2LiCoO₂ (discharge); (iii) Ni(OH)₂ cathode in rechargeable alkaline batteries: Ni(OH)₂→NiOOH+H⁺+e⁻ (charge); (iv) MnO₂ in saline Zn/MnO₂ primary batteries: MnO₂+H⁺+e⁻→HMnO₂ (discharge).
2. Anion based electrode reactions: In these reactions, the electrode captures or releases an anion X⁻ from electrolyte and an electron from the external circuit:

Electrode+X⁻→Electrode(X)+e⁻

Examples of anion based electrode reactions include: (i) Cadmium anode in the Nickel-Cadmium alkaline battery: Cd(OH)₂+2e⁻→Cd+2OH⁻ (charge); and (ii) Magnesium alloy anode in the magnesium primary batteries: Mg+2OH⁻→Mg(OH)₂+2e⁻ (discharge).

Existing batteries are either of pure cation-type or mixed ion-type chemistries. Examples of pure cation-type and mixed ion-type batteries are provided below:
1. Pure cation-type of battery: Lithium ion batteries are an example of pure cation-type chemistry. The electrode half reactions and cell reactions for lithium ion batteries are:

Carbon anode:

6C+Li⁺+e⁻→LiC₆ (charge)

lithium cobalt oxide cathode:

2Li_{0.5}CoO₂+Li⁺+e⁻→2LiCoO₂ (discharge)

cell reaction:

2LiCoO₂+6C→2Li_{0.5}CoO₂+LiC₆ (charge)

2Li_{0.5}CoO₂+LiC₆→2LiCoO₂+6C (discharge)
2. Mixed ion-type of battery: A Nickel/cadmium alkaline battery is an example of a mixed ion-type of battery. The electrode half reactions and cell reactions for a Nickel/cadmium alkaline battery are provided below:

Ni(OH)₂ cathode (cation-type):

Ni(OH)₂→NiOOH+H⁺+e⁻ (charge)

Cadmium anode (anion-type):

Cd(OH)₂+2e⁻→Cd+2OH⁻ (charge)

Cell reaction:

Cd(OH)₂+2Ni(OH)₂→Cd+2NiOOH+2H₂O (charge)

Cd+2NiOOH+2H₂O→Cd(OH)₂+2Ni(OH)₂ (discharge)

A Zn/MnO₂ battery is an example of a mixed ion-type of battery. The electrode half reactions and cell reactions for a Zn/MnO₂ battery are provided below:

Zn anode (anion-type):

Zn+2OH⁻→ZnO+H₂O+2e⁻ (discharge)

MnO₂ cathode (cation-type)

MnO₂+H⁺+e⁻→HMnO₂ (discharge)

Cell reaction:

Zn+2MnO₂+H₂O→ZnO+2HMnO₂ (discharge)

As will be clear from the foregoing, there exists a need in the art for electrochemical cells and cell components for a range of important device applications including the rapidly increasing demand for high performance portable electronics and electric and hybrid electric vehicles.

### SUMMARY

Described herein are high performance electrodes for use in electrochemical systems, such as electrochemical generators including primary and secondary batteries and fuel cells. Electrodes described herein are capable of effective replenishing and/or regeneration, and thereby enable an innovative class of electrochemical systems capable of efficient recharging and/or electrochemical cycling. In addition, electrodes described herein enable electrochemical generators combining high energy density and enhanced safety with respect to conventional lithium ion battery technology. In some embodiments, for example, an electrode is provided comprising a fluorinated or metalloprotein oxygen dissolution enhancer provided in a solvent for enhancing dissolution of oxygen in the solvent. In a related embodiment, a metal oxide dissolution enhancer is provided in the solvent for enhancing dissolution of metal oxide formed via reaction of oxygen with metal ions in the solvent. The oxygen and metal oxide dissolution enhancers described herein enable an increase of the oxidation and/or reduction rate and enhance the stability and efficiency of the electrochemical generators described herein. Positive electrodes described herein, for example, are highly versatile and compatible with a wide range of solid state and liquid anode and electrolyte systems, including anodes comprising readily available and inexpensive materials such as solvated electron solutions as well as a range of solid state anodes.

The invention relates to soluble electrodes, including soluble anodes, for use in electrochemical systems, such as electrochemical generators including primary and secondary batteries and fuel cells. Soluble electrodes of the invention are capable of effective replenishing and/or regeneration, and thereby enable an innovative class of electrochemical systems capable of efficient recharging and/or electrochemical cycling. In addition, soluble electrodes of the invention provide electrochemical generators combining high energy density and enhanced safety with respect to conventional lithium ion battery technology. In some embodiments, for example, the invention provides a soluble electrode comprising an electron donor metal and electron acceptor provided in a solvent so as to generate a solvated electron solution capable of participating in oxidation and reduction reactions useful for the storage and generation of electrical current. Soluble negative electrodes of the present invention, for example, are highly versatile and compatible with a wide range of solid state and liquid cathode and electrolyte systems, including cathodes comprising readily available and inexpensive materials such as water and air as well as a range of solid state cathodes.

In an embodiment, the invention provides an electrode for use in an electrochemical generator, the electrode comprising: a solvent having metal ions and oxygen dissolved therein, wherein the metal ions are alkali metal ions, alkali earth metal ions, or lanthanide metal ions; a fluorinated or metalloprotein oxygen dissolution enhancer provided in the solvent for enhancing dissolution of the oxygen in the solvent; a metal oxide dissolution enhancer provided in the solvent, the metal oxide dissolution enhancer for enhancing dissolution of metal oxide formed via reaction of the oxygen with the metal ions in the solvent; and a current collector provided in electrical contact with the solvent.

In another embodiment, the invention provides an electrochemical generator comprising: a positive electrode comprising: a solvent having metal ions and oxygen dissolved therein, wherein the metal ions are alkali metal ions, alkali earth metal ions, or lanthanide metal ions; a fluorinated or metalloprotein oxygen dissolution enhancer provided in the solvent for enhancing dissolution of the oxygen in the solvent; a metal oxide dissolution enhancer provided in the solvent, the metal oxide dissolution enhancer for enhancing dissolution of metal oxide formed via reaction of the oxygen with the metal ions in the solvent; a current collector provided in electrical contact with the solvent; a negative electrode comprising an active negative electrode material; and a separator provided between the negative electrode and the positive electrode, wherein the separator conducts metal ions as a charge carrier in the electrochemical generator.

In another embodiment, the invention provides an electrochemical generator comprising: a positive electrode comprising: a first solvent having electron donor metal ions and oxygen dissolved therein, wherein the electron donor metal ions are alkali metal ions, alkali earth metal ions, lanthanide metal ions, or a mixture thereof; a fluorinated or metalloprotein oxygen dissolution enhancer provided in the first solvent for enhancing dissolution of the oxygen in the first solvent; a metal oxide dissolution enhancer provided in the first solvent, the metal oxide dissolution enhancer for enhancing dissolution of electron donor metal oxide formed via reaction of the oxygen with the electron donor metal ions in the first solvent; a current collector provided in electrical contact with the first solvent; a negative soluble electrode comprising: an electron donor comprising an electron donor metal provided in a second solvent, wherein the electron donor metal is an alkali metal, an alkali earth metal, a lanthanide metal or alloy thereof; an electron acceptor provided in the second solvent, wherein the electron acceptor is a polycyclic aromatic hydrocarbon or an organo radical; a supporting electrolyte comprising a metal at least partially dissolved in the second solvent; a current collector provided in contact with the second solvent; wherein at least a portion of the electron donor comprising an electron donor metal is dissolved in the second solvent, thereby generating electron donor metal ions and solvated electrons in the second solvent; and a separator provided between the negative soluble electrode and the positive electrode, wherein the separator is non-liquid and conducts the electron donor metal ions as a charge carrier in the electrochemical generator.

In another embodiment, the invention provides an electrochemical generator comprising: a positive electrode comprising: a first solvent having metal ions and oxygen dissolved therein, wherein the metal ions are lithium ions; a fluorinated or metalloprotein oxygen dissolution enhancer provided in the first solvent for enhancing dissolution of the oxygen in the first solvent; a metal oxide dissolution enhancer provided in the first solvent, the metal oxide dissolution enhancer for enhancing dissolution of lithium oxide formed via reaction of the oxygen with the lithium ions in the first solvent; a current collector provided in electrical contact with the first solvent; a negative soluble electrode comprising: an electron donor comprising an electron donor metal provided in a second solvent, wherein the electron donor metal is lithium; an electron acceptor provided in the second solvent, wherein the electron acceptor is a polycyclic aromatic hydrocarbon; a supporting electrolyte comprising a metal at least partially dissolved in the second solvent; a current collector provided in contact with the second solvent; wherein at least a portion of the electron donor comprising an electron donor metal is dissolved in the second solvent, thereby generating lithium ions and solvated electrons in the second solvent; and a separator provided between the negative soluble electrode and the positive electrode, wherein the separator is non-liquid and conducts the lithium ions as a charge carrier in the electrochemical generator.

In another embodiment, the invention provides an electrochemical generator comprising: a positive electrode comprising: a first solvent having metal ions and oxygen dissolved therein, wherein the metal ions are sodium ions; a fluorinated or metalloprotein oxygen dissolution enhancer provided in the first solvent for enhancing dissolution of the oxygen in the first solvent; a metal oxide dissolution enhancer provided in the first solvent, the metal oxide dissolution enhancer for enhancing dissolution of sodium oxide formed via reaction of the oxygen with the sodium ions in the first solvent; a current collector provided in electrical contact with the first solvent; a negative soluble electrode comprising: an electron donor comprising an electron donor metal provided in a second solvent, wherein the electron donor metal is sodium; an electron acceptor provided in the second solvent, wherein the electron acceptor is a polycyclic aromatic hydrocarbon; a supporting electrolyte comprising a metal at least partially dissolved in the second solvent; a current collector provided in contact with the second solvent; wherein at least a portion of the electron donor comprising an electron donor metal is dissolved in the second solvent, thereby generating sodium ions and solvated electrons in the second solvent; and a separator provided between the negative soluble electrode and the positive electrode, wherein the separator is non-liquid and conducts the sodium ions as a charge carrier in the electrochemical generator.

In another embodiment, the invention provides an electrochemical generator comprising: a positive electrode comprising: a first solvent having electron donor metal ions and oxygen dissolved therein, wherein the electron donor metal ions are alkali metal ions, alkali earth metal ions, lanthanide metal ions, or a mixture thereof; a fluorinated or metalloprotein oxygen dissolution enhancer provided in the first solvent for enhancing dissolution of the oxygen in the first solvent; wherein the fluorinated or metalloprotein oxygen dissolution enhancer is a fluorinated ether, a fluorinated ester, a fluorinated carbonate, a fluorinated polymer, or mixture thereof; a metal oxide dissolution enhancer provided in the first solvent, the metal oxide dissolution enhancer for enhancing dissolution of electron donor metal oxide formed via reaction of the oxygen with the electron donor metal ions in the first solvent; a current collector provided in electrical contact with the first solvent; a negative soluble electrode comprising: an electron donor comprising an electron donor metal provided in a second solvent, wherein the electron donor metal is an alkali metal, an alkali earth metal, a lanthanide metal or alloy thereof; an electron acceptor provided in the second solvent, wherein the electron acceptor is a polycyclic aromatic hydrocarbon or an organo radical; a supporting electrolyte comprising a metal at least partially dissolved in the second solvent; a current collector provided in contact with the second solvent; wherein at least a portion of the electron donor comprising an electron donor metal is dissolved in the second solvent, thereby generating electron donor metal ions and solvated electrons in the second solvent; and a separator provided between the negative soluble electrode and the positive electrode, wherein the separator is non-liquid and conducts the electron donor metal ions as a charge carrier in the electrochemical generator.

In an aspect, the invention provides electrochemical generators wherein during discharge of the electrochemical generator, the metal ions are released from the negative electrode and stored by the positive electrode; and wherein during charging of the electrochemical generator, the metal ions are released from the positive electrode and stored by the negative electrode.

The present electrodes and electrochemical generators can further comprise a number of additional components. In an embodiment, for example, the electrode or electrochemical generator further comprises a port in fluid connection with the current collector for providing or removing the solvent, the metal oxide dissolution enhancer, the fluorinated or metalloprotein oxygen dissolution enhancer, or a mixture thereof. In an embodiment, the electrode or electrochemical generator further comprises an oxygen reduction catalyst provided in physical contact with the solvent and the current collector. In an aspect of this embodiment, the oxygen reduction catalyst is provided as an outer layer of the current collector exposed to the solvent. In another embodiment, the oxygen reduction catalyst comprises a transition metal, a transition metal alloy, a transition metal oxide, a transition metal nitride, a transition metal carbide, a transition metal silicide, or a combination thereof. In a further embodiment, the oxygen reduction catalyst comprises a noble metal, an organo-metallic compound, a cobalt porphyrine, or a combination thereof. In another embodiment, the oxygen reduction catalyst comprises a conjugated polymer or combination of conjugated polymers. In a further aspect, the conjugated polymer or combination of conjugated polymers comprises polypyrrole, polyaniline, polyacetylene, polyparaphenylene, polythiophene or a combination thereof. In another aspect, the oxygen reduction catalyst comprises cobalt phthalocyanine, (5,10,15,20-tetramethylporphyrinato) cobalt(II), ferrocene, or a combination thereof.

A range of solvents are useful with the electrodes and electrochemical generators of the invention. In an embodiment, for example, the solvent is water or an organic solvent. In an aspect of this embodiment, the organic solvent comprises an alkyl carbonate, an ether, an ester, or a combination thereof.

The metal oxide dissolution enhancers of electrodes and electrochemical generators of the present invention are useful to enhance dissolution of a wide range of metal oxides. In an embodiment, for example, the metal oxide has the formula M_{y}Oₓ, wherein M is an electron donor metal, y is 1, 2 or 3 and x is 1, 2, 3 or 4. In an aspect, the electron donor metal is lithium, sodium, potassium, rubidium, magnesium, calcium, aluminum, zinc, carbon, silicon, germanium, lanthanum, europium, cerium, strontium, barium or alloy thereof. In an aspect, the electron donor metal is a metal other than lithium.

A range of fluorinated or metalloprotein oxygen dissolution enhancers are useful in electrodes and electrochemical generators of the invention. In an embodiment, for example, electrodes or electrochemical generators are provided wherein the concentration of the fluorinated or metalloprotein oxygen dissolution enhancer in the solvent is greater than or equal to about 0.1 M, optionally for some applications greater than or equal to 0.2 M and optionally for some applications greater than or equal to 1 M. In some embodiments, the concentration of the fluorinated or metalloprotein oxygen dissolution enhancer in the solvent is selected over the range of 0.1 M to 15 M, optionally for some applications selected over the range of 0.2 M to 5 M and optionally for some applications selected over the range of 0.2 M to 2 M. In another embodiment, the fluorinated or metalloprotein oxygen dissolution enhancer is a fluorinated polymer. In an aspect, the fluorinated polymer is polytetrafluoroethylene (PTFE); perfluoroalkoxy polymer (PFA); fluorinated ethylene propylene (FEP); ethylene tetrafluoroethylene (ETFE); ethylene chlorotrifluoroethylene (ECTFE); polyvinylidene fluoride (PVDF); polychlorotrifluoroethylene (PCTFE); a polymethylene-type perfluoro rubber having all substituents on the polymer chain either fluoro, perfluoroalkyl or perfluoroalkoxy groups (FFKM); a polymethylene-type fluororubber having fluoro and perfluoroalkoxy substituent groups in the main chain (FKM); polyvinylfluoride (PVF); perfluoropolyether (PFPE); Nafion; or combination thereof.

In another embodiment, for example, the fluorinated or metalloprotein oxygen dissolution enhancer is a fluorinated ether, a fluorinated ester, a fluorinated carbonate, a fluorinated carbon material, a fluorinated blood substitute, a metalloprotein, or a mixture thereof. In an aspect, the fluorinated or metalloprotein oxygen dissolution enhancer is a fluorinated ether having the general formula Cₘ₊ₙH₂ₙ₊₁F₂ₙ₊₁O; wherein n is an integer from 1 to 10 and m is an integer from 1 to 10. In a related aspect, the fluorinated ether is: 1-(difluoromethoxy)-1,1,2-trifluoroethane; 1-(difluoromethoxy)-1,2,2-trifluoroethane; 2-fluoromethoxy-1,1,1,2-tetrafluoroethane; 1-methoxy-1,1,2,2-tetrafluoroethane; 2-methoxy-1,1,1,2-tetrafluoroethane; 1-difluoromethoxy-2,-2-difluoroethane; 2-methoxy-1,1,2-trifluoroethane; 1,1-difluoro-2-methoxyethane; 1,1,2,2-tetrafluoro-3-(trifluoromethoxy)propane; 1-(2,2-difluoroethoxy)-1,1,2,2,2-pentafluoroethane; 3-(difluoromethoxy)-1,1,1,2,2-pentafluoropropane; 1,1,1,3,3,3-hexafluoro-2-(trifluoromethoxy)propane; 1,1,2-trifluoro-1-methoxy-2-(trifluoromethoxy)ethane; 1,1,1,2,3,3-hexafluoro-3-methoxypropane; 1,1,2,2,3,3-hexafluoro-3-methoxypropane; 1-(1,1,-difluoroethoxy)-1,1,2,2-tetrafluoroethane; 3-(difluoromethoxy)-1,1,2,2-tetrafluoropropane; 1,1,1,2,2-pentafluoro-3-methoxypropane; 2-(difluoromethoxy)-1,1,1-trifluoropropane; 2-ethoxy-1,1,1,2-tetrafluoroethane; 1,1,1-trifluoro-2-ethoxyethane; 1,1,1-trifluoro-3-methoxypropane; 1,1,1-trifluoro-2-methoxypropane; 1-ethoxy-1,2,2-trifluoroethane; 1,1,1,2,3,3-hexafluoro-3-(pentafluoroethoxy)propane; 2-ethoxy-1,1,1,2,3,3,3-heptafluoropropane: 3-ethoxy-1,1,1,2,2,3,3-heptafluoropropane; 1-(1,1,2,2-tetrafluoroethoxy)propane; 2,3-difluoro-4-(trifluoromethyl)oxetane; 1-ethoxy-1,1,2,2-tetrafluoroethane; or 1,1,1,2,2,3,3-heptafluoro-3-methoxypropane. In another aspect, for example, the fluorinated or metalloprotein oxygen dissolution enhancer is a fluorinated ester having a general formula of Cₘ₊ₙH₂ₘ₊₁F₂ₙ₊₁C(O)O; wherein n is an integer from 1 to 10 and m is an integer from 1 to 10. In a further aspect, the fluorinated or metalloprotein oxygen dissolution enhancer is a fluorinated carbonate having a general formula of Cₘ₊ₙF₂ₘ₊₁F₂ₙ₊₁CH(CO₃); wherein n is an integer from 1 to 10 and m is an integer from 1 to 10.

In another embodiment, for example, the fluorinated or metalloprotein oxygen dissolution enhancer is a fluorinated carbon material. In an aspect the fluorinated carbon material is a solid state material having a general formula of CFₓ; wherein 0.01<x<2. In another embodiment, the fluorinated or metalloprotein oxygen dissolution enhancer is a fluorinated blood substitute. In an aspect, the fluorinated blood substitute is a fluorocarbon having a general formula CₙFₘ; wherein n is an integer from 1 to 20 and m is an integer from 2 to 42; or the fluorinated blood substitute is a hydrofluorocarbon having a general formula CₙFₚH_{q}; wherein n is an integer from 1 to 20, p is an integer from 2 to 41, and q is an integer from 2 to 41. In another aspect, the fluorinated blood substitute is perfluorodecalin. In a further aspect, the fluorinated blood substitute is present as an emulsion in the solvent. In an aspect, the fluorinated or metalloprotein oxygen dissolution enhancer is an ironprotein. In another aspect, the ironprotein is hemoglobin. In an aspect, the fluorinated blood substitute is a perfluorocarbon (PFC) of general formula CₙFₘ; wherein n is an integer from 1 to 20 and m is an integer ≦2n+2. In a further aspect, the fluorinated blood substitute is a perfluoroalkyl of general formula CₙFₚH_{q}; wherein n is an integer from 1 to 20, and p and q are each independently integers from 2 to 41. In a further aspect, the fluorinated blood substitute is a perfluooctyl ethane having formula C₁₀F₁₇C₂H₅ or C₁₀F₁₇H₅. In another aspect, the fluorinated blood substitute is a perfluoroalkyl halide or perfluoroalkyl halide derivative. Perfluoroalkyl halides and perfluoroalkyl halide derivatives are known in the art. [See, for example, U.S. Pat. No. 5,852,148.] In an aspect, the fluorinated blood substitute is a perfluorooctyle bromide having formula C₈F₁₇Br; a perfluoroalkyl acid; or a perfluoroalkyl acid derivative. Perfluoroalkyl acids and perfluoroalkyl acid derivatives are known in the art. [See, for example, U.S. Pat. Nos. 3,856,849, 5,194,648, 3,910,886 and International Patent Application Publication No. WO/2000/043438.] In an embodiment, the fluorinated blood substitute is a perfluorooctanoic acid having formula C₈HF₁₅O₂; an ammonium perfluoralkyl sulfonate having formula CₙF₂ₙ₊₁SO₃NH₄; wherein 1≦n≦20; or a perfluoroalkyl sulfonamide having formula CₙF₂ₙ₊₁SO₂NH₂; wherein 1≦n≦20.

A wide range of metal oxide dissolution enhancers are useful in the electrodes and electrochemical generators of the invention. In an embodiment, for example, electrodes or electrochemical generators are provided wherein the concentration of the metal oxide dissolution enhancer in the solvent is greater than or equal to about 0.1 M, optionally for some applications greater than or equal to 0.2 M and optionally for some applications greater than or equal to 1 M. In some embodiments, the concentration of the metal oxide dissolution enhancer in the solvent is selected over the range of 0.1 M to 15 M, optionally for some applications selected over the range of 0.2 M to 5 M and optionally for some applications selected over the range of 0.2 M to 2 M. In another embodiment, the metal oxide dissolution enhancer comprises an anion receptor, crown ether, cation receptor, a lithium salt dissolved in an organic or inorganic solvent, an ionically conducting polymer, an ionic liquid, a fused lithium salt, or a mixture thereof. In an aspect, the metal oxide dissolution enhancer comprises a lithium salt dissolved in a linear or cyclic ester, a linear or cyclic ether, acetonitrile, γ-butyrolactone, or a mixture thereof. In a further aspect, the metal oxide dissolution enhancer comprises a lithium salt dissolved in methyl formate, ethylene carbonate, dimethyl carbonate, propylene carbonate, or mixture thereof. In another aspect, the metal oxide dissolution enhancer comprises a lithium salt dissolved in dimethoxyethane, dioxolanes, or mixture thereof. In a further aspect, the metal oxide dissolution enhancer comprises lithium and a complex anion. In an aspect, the metal oxide dissolution enhancer comprises LiClO₄, LiBF₄, LiAsF₆, LiSbF₆, LiAlCl₄, LiPF₆, or mixture thereof. In a further aspect, the metal oxide dissolution enhancer is: LiPF₆ in ethylene carbonate and dimethyl carbonate; LiBF₄ in gamma butyrolactone; LiClO₄ in propylene carbonate; 15-crown-5 ether; NaPF₆ in CH₃CN; propylene carbonate in 12-crown-4 ether; or 1-butyl-3-methylimidazolium hexafluorophosphate.

A wide range of current collectors are useful in the electrodes and electrochemical generators of the invention. In an embodiment, for example, the current collector comprises porous carbon, a nickel metal grid, a nickel metal mesh, a nickel metal foam, a copper metal grid, a copper metal mesh, a copper metal foam, a titanium metal grid, a titanium metal mesh, a titanium metal foam, a molybdenum metal grid, a molybdenum metal mesh, or a molybdenum metal foam.

In an embodiment of the invention, the invention provides a method of generating an electrical current, the method comprising: providing an electrochemical generator, the generator comprising: a positive electrode comprising: a first solvent having metal ions and oxygen dissolved therein, wherein the metal ions are alkali metal ions, alkali earth metal ions, or lanthanide metal ions; a fluorinated or metalloprotein oxygen dissolution enhancer provided in the first solvent for enhancing dissolution of the oxygen in the first solvent; a metal oxide dissolution enhancer provided in the first solvent, the metal oxide dissolution enhancer for enhancing dissolution of metal oxide formed via reaction of the oxygen with the metal ions in the first solvent; a current collector provided in electrical contact with the first solvent; a negative soluble electrode comprising: an electron donor comprising an electron donor metal provided in a second solvent, wherein the electron donor metal is an alkali metal, an alkali earth metal, a lanthanide metal or alloy thereof; an electron acceptor provided in the second solvent, wherein the electron acceptor is a polycyclic aromatic hydrocarbon or an organo radical; a supporting electrolyte comprising a metal at least partially dissolved in the second solvent; a current collector provided in contact with the second solvent; wherein at least a portion of the electron donor comprising an electron donor metal is dissolved in the second solvent, thereby generating electron donor metal ions and solvated electrons in the second solvent; a separator provided between the negative soluble electrode and the positive electrode, wherein the separator is non-liquid and conducts the electron donor metal ions as a charge carrier in the electrochemical generator; and discharging the electrochemical generator.

In an embodiment of the invention, the invention provides a method of charging an electrochemical generator, the method comprising: providing an electrochemical generator, the generator comprising: a positive electrode comprising: a first solvent having metal ions and oxygen dissolved therein, wherein the metal ions are alkali metal ions, alkali earth metal ions, or lanthanide metal ions; a fluorinated or metalloprotein oxygen dissolution enhancer provided in the first solvent for enhancing dissolution of the oxygen in the first solvent; a metal oxide dissolution enhancer provided in the first solvent, the metal oxide dissolution enhancer for enhancing dissolution of metal oxide formed via reaction of the oxygen with the metal ions in the first solvent; a current collector provided in electrical contact with the first solvent; a negative soluble electrode comprising: an electron donor comprising an electron donor metal provided in a second solvent, wherein the electron donor metal is an alkali metal, an alkali earth metal, a lanthanide metal or alloy thereof; an electron acceptor provided in the second solvent, wherein the electron acceptor is a polycyclic aromatic hydrocarbon or an organo radical; a supporting electrolyte comprising a metal at least partially dissolved in the second solvent; a current collector provided in contact with the second solvent; wherein at least a portion of the electron donor comprising an electron donor metal is dissolved in the second solvent, thereby generating electron donor metal ions and solvated electrons in the second solvent; a separator provided between the negative soluble electrode and the positive electrode, wherein the separator is non-liquid and conducts the electron donor metal ions as a charge carrier in the electrochemical generator; selecting a charging voltage and/or current for charging the electrochemical generator; and providing the selected voltage and/or current to the electrodes of the electrochemical generator to charge the electrochemical generator. In an aspect of this embodiment, the voltage and/or current provided to the electrochemical generator is preselected according to the number of charge/discharges cycles the electrochemical generator has experienced.

In an embodiment of the invention, the invention provides a method of discharging and refueling an electrochemical generator, the method comprising: providing an electrochemical generator, the generator comprising: a positive electrode comprising: a first solvent having metal ions and oxygen dissolved therein, wherein the metal ions are alkali metal ions, alkali earth metal ions, or lanthanide metal ions; a fluorinated or metalloprotein oxygen dissolution enhancer provided in the first solvent for enhancing dissolution of the oxygen in the first solvent; a metal oxide dissolution enhancer provided in the first solvent, the metal oxide dissolution enhancer for enhancing dissolution of metal oxide formed via reaction of the oxygen with the metal ions in the first solvent; a current collector provided in electrical contact with the first solvent; a negative soluble electrode comprising: an electron donor comprising an electron donor metal provided in a second solvent, wherein the electron donor metal is an alkali metal, an alkali earth metal, a lanthanide metal or alloy thereof; an electron acceptor provided in the second solvent, wherein the electron acceptor is a polycyclic aromatic hydrocarbon or an organo radical; a supporting electrolyte comprising a metal at least partially dissolved in the second solvent; a current collector provided in contact with the second solvent; wherein at least a portion of the electron donor comprising an electron donor metal is dissolved in the second solvent, thereby generating electron donor metal ions and solvated electrons in the second solvent; a separator provided between the negative soluble electrode and the positive electrode, wherein the separator is non-liquid and conducts the electron donor metal ions as a charge carrier in the electrochemical generator; discharging the electrochemical generator, thereby generating a discharged electrochemical generator; removing substantially all of the electron donor metal, electron acceptor and second solvent from the soluble negative electrode from the discharged electrochemical generator; providing electron donor metal, electron acceptor and second solvent to the soluble negative electrode to the discharged electrochemical generator; removing substantially all of the first solvent, fluorinated or metalloprotein oxygen dissolution enhancer, and metal oxide dissolution enhancer from the positive electrode from the discharged electrochemical generator; and providing first solvent, fluorinated or metalloprotein oxygen dissolution enhancer, and metal oxide dissolution enhancer to the positive electrode to the discharged electrochemical generator; thereby refueling the electrochemical generator.

In an embodiment, the invention provides a soluble electrode for use in an electrochemical generator, the soluble electrode comprising: an electron donor comprising an electron donor metal provided in a solvent, wherein the electron donor metal is an alkali metal, an alkali earth metal, a lanthanide metal or alloy thereof; an electron acceptor provided in the solvent; wherein the electron acceptor is a polycyclic aromatic hydrocarbon or an organo radical; wherein at least a portion of the electron donor comprising an electron donor metal is dissolved in the solvent, thereby generating electron donor metal ions and solvated electrons in the solvent. In an embodiment, the soluble electrode further comprises a source of the electron donor metal, the electron acceptor or the solvent operationally connected to the electrode, such as an inlet capable of providing additional electron donor metal, electron acceptor or solvent to the electrode and/or an outlet for removing the electron donor metal, the electron acceptor or the solvent operationally connected to the electrode.

In another embodiment, the invention provides a soluble electrode for use in an electrochemical generator, the soluble electrode comprising: an electron donor comprising an electron donor metal provided in a solvent, wherein the electron donor metal is an alkali metal, an alkali earth metal, a lanthanide metal or alloy thereof; an electron acceptor provided in the solvent, wherein the electron acceptor is a polycyclic aromatic hydrocarbon or an organo radical; a supporting electrolyte comprising a metal at least partially dissolved in the solvent; wherein at least a portion of the electron donor comprising an electron donor metal is dissolved in the solvent, thereby generating electron donor metal ions and solvated electrons in the solvent. In an embodiment, the soluble electrode further comprises a source of the electron donor metal, the electron acceptor or the solvent operationally connected to the electrode, such as an inlet capable of providing additional electron donor metal, electron acceptor or solvent to the electrode and/or an outlet for removing the electron donor metal, the electron acceptor or the solvent operationally connected to the electrode.

In another embodiment, the invention provides an electrochemical generator comprising: a negative soluble electrode comprising: an electron donor comprising an electron donor metal provided in a first solvent, wherein the electron donor metal is an alkali metal, an alkali earth metal, a lanthanide metal or alloy thereof; an electron acceptor provided in the first solvent, wherein the electron acceptor is a polycyclic aromatic hydrocarbon or an organo radical; wherein at least a portion of the electron donor comprising an electron donor metal is dissolved in the first solvent, thereby generating electron donor metal ions and solvated electrons in the first solvent; a positive electrode comprising an active positive electrode material; and a separator provided between the negative soluble electrode and the positive electrode, wherein the separator is non-liquid and conducts the electron donor metal ions as a charge carrier in the electrochemical generator. In an embodiment, the electrochemical generator further comprises a source of the electron donor metal, the electron acceptor or the solvent operationally connected to the soluble negative electrode, such as an inlet capable of providing additional electron donor metal, electron acceptor or solvent to the negative electrode.

A range of electron donor metals are useful in the present invention. Metals capable of losing electrons to form strongly reductive solutions, such as alkali metals and alkali earth metals, are particularly useful in certain soluble electrodes and electrochemical generators of the invention. In some embodiments, for example, the electron donor metal of the soluble electrode and/or electrochemical generator is lithium, sodium, potassium, rubidium, magnesium, calcium, aluminum, zinc, carbon, silicon, germanium, lanthanum, europium, strontium or an alloy of these metals. In some embodiments the electron donor metal may be provided as a metal hydride, a metal aluminohydride, a metal borohydride, a metal aluminoborohydride or metal polymer. Metal hydrides are known in the art, for example in A. Hajos, “Complex Hydrides”, Elservier, Amsterdam, 1979 which is incorporated by reference herein in its entirety to the extent not inconsistent with the present description. In some embodiments, the electron donor metal of the soluble electrode and/or electrochemical generator is a metal other than lithium. Avoidance of metallic lithium is desirable in some embodiments to provide soluble electrodes and electrochemical systems providing enhanced safety upon recharging and cycling relative to conventional lithium ion systems. In addition, use of metals other than lithium can increase the ionic conductivity of the separator and increase the efficiency of the electrochemical generators of the invention. In some embodiments, the concentration of the electron donor metal ions in the solvent is greater than or equal to about 0.1 M, optionally for some applications greater than or equal to 0.2 M and optionally for some applications greater than or equal to 1 M. In some embodiments, the concentration of the electron donor metal ions in the solvent is selected over the range of 0.1 M to 10 M, optionally for some applications selected over the range of 0.2 M to 5 M and optionally for some applications selected over the range of 0.2 M to 2 M.

A range of electron acceptors are useful in the present soluble electrodes and electrochemical generators, including polycyclic aromatic hydrocarbons and organo radicals. Useful polycyclic aromatic hydrocarbons include Azulene, Naphthalene, 1-Methylnaphthalene, Acenaphthene, Acenaphthylene, Anthracene, Fluorene, Phenalene, Phenanthrene, Benzo[a]anthracene, Benzo[a]phenanthrene, Chrysene, Fluoranthene, Pyrene, Tetracene, Triphenylene Anthanthrene, Benzopyrene, Benzo[a]pyrene, Benzo[e]fluoranthene, Benzo[ghi]perylene, Benzo[j]fluoranthene, Benzo[k]fluoranthene, Corannulene, Coronene, Dicoronylene, Helicene, Heptacene, Hexacene, Ovalene, Pentacene, Picene, Perylene, Tetraphenylene, and mixtures of these. Some organo radicals of the present soluble electrodes and electrochemical generators react via a charge transfer, partial electron transfer, or full electron transfer reaction with the electron donor metal to form an organometallic reagent. Useful organo radicals include, for example, alkyl radicals (such as butyl radical or acetyl radical), allyl radicals, amino radicals, imido radicals and phosphino radicals. In some embodiments, the concentration of the electron acceptor in the solvent is greater than or equal to about 0.1 M, optionally for some applications greater than or equal to 0.2 M and optionally for some applications greater than or equal to 1 M. In some embodiments, the concentration of the electron acceptor in the solvent is selected over the range of 0.1 M to 15 M, optionally for some applications selected over the range of 0.2 M to 5 M and optionally for some applications selected over the range of 0.2 M to 2 M.

A range of solvents are useful in the present soluble electrodes and electrochemical generators. Solvents capable of dissolving significant amounts of (e.g., generating 0.1-15 M solutions of) electron donor metals and electron acceptors are preferred for some applications. In some embodiments, for example, the solvent is water, tetrahydrofuran, hexane, ethylene carbonate, propylene carbonate, benzene, carbon disulfide, carbon tetrachloride, diethyl ether, ethanol, chloroform, ether, dimethyl ether, benzene, propanol, acetic acid, alcohols, isobutylacetate, n-butyric acid, ethyl acetate, N-methyl pyrrolidone, N,N-dimethyl formiate, ethylamine, isopropyl amine, hexamethylphosphotriamide, dimethyl sulfoxide, tetralkylurea, triphenylphosphine oxide or mixture thereof. In some embodiments, a mixture of solvents will be desirable such that one solvent of the mixture can solvate a electron acceptor while another solvent of the mixture can solvate a supporting electrolyte. Suitable solvents are known in the art, for example in “Lithium Ion Batteries Science and Technology”, Gholam-Abbas Nazri and Gianfranco Pistoia Eds., Springer, 2003, which is hereby incorporated by reference in its entirety.

In an aspect, for example, a supporting electrolyte comprises: MXₙ, MO_{q}, MY_{q}, or M(R)ₙ; wherein M is a metal; X is F, Cl, Br, or I; Y is S, Se, or Te; R is a group corresponding to a carboxylic group, alcohoate, alkoxide, ether oxide, acetate, formate, or carbonate; wherein n is 1, 2, or 3; and q is greater than 0.3 and less than 3.

The present soluble electrodes and electrochemical generators may further comprise a number of additional components. In an embodiment, the soluble anode further comprises a current collector provided in contact with the solvent of the positive electrode. Useful current collectors include, for example, porous carbon, a nickel metal grid, a nickel metal mesh, a nickel metal foam, a copper metal grid, a copper metal mesh, a copper metal foam, a titanium metal grid, a titanium metal mesh, a titanium metal foam, a molybdenum metal grid, a molybdenum metal mesh, and a molybdenum metal foam. Optionally, the current collector further comprises a catalyst provided to facilitate electron transport into and/or out of the current collector, such as an external catalyst layer on the outer surface of the current collector. Suitable current collectors are known in the art, for example in U.S. Pat. No. 6,214,490, which is hereby incorporated by reference in its entirety.

The separator component of the present electrochemical generators function to conduct the electron donor metal ions between the soluble negative electrode to the positive electrode during discharge and charging of the electrochemical generator. Alternatively the separator component of the present invention is an anion conductor or a cation and anion mixed conductor. Preferably, the separator does not substantially conduct electrons between the soluble negative electrode and the positive electrode (e.g., conductivity less than or equal to 10⁻¹⁵ S cm⁻¹) and is substantially impermeable to the first solvent of the negative soluble electrode. Useful separators include ceramics, glasses, polymers, gels, and combinations of these. In an embodiment, for example, the separator comprises an electron donor metal, an organic polymer, an oxide glass, an oxynitiride glass, a sulfide glass, an oxysulfide glass, a thionitril glass, a metal halide doped glass, a crystalline ceramic electrolyte, a perovskite, a nasicon type phosphate, a lisicon type oxide, a metal halide, a metal nitride, a metal phosphide, a metal sulfide, a metal sulfate, a silicate, an aluminosilicate or a boron phosphate. The thickness of the separator can be selected so as to maximize tensile strength or to maximize ionic conductivity. In an aspect the thickness of the separator is selected over the range of 50 μm to 10 mm. For some applications the thickness is selected over the range of 50 μm to 250 μm, more preferably over the range of 100 μm to 200 μm. The electrical conductivity of the separator should be very low in order to not conduct solvated electrons between the soluble anode and the cathode. In some aspects, the electrical conductivity of the separator is less than 10⁻¹⁵ S/cm. Separators are known in the art, for example in U.S. Pat. Nos. 5,702,995, 6,030,909, 6,475,677 and 6,485,622 and in “Topics in Applied Physics, Solid Electrolytes”, S. Geller, Editor, Springler-Verlag, 1977 which are each hereby incorporated by reference in their entireties to the extent not inconsistent with the present description.

In an embodiment, for example, the separator is a supported membrane comprising an electron donor metal component and a structural support component. In an embodiment the electron donor metal component, for example, comprises a ceramic, an organic polymer, an oxide glass, an oxynitiride glass, a sulfide glass, an oxysulfide glass, a thionitril glass, a metal halide doped glass, a crystalline ceramic electrolyte, a perovskite, a nasicon type phosphate, a lisicon type oxide, a metal halide, a metal nitride, a metal phosphide, a metal sulfide, a metal sulfate, a silicate, an aluminosilicate or a boron phosphate. In an embodiment, the structural support component, for example, comprises silicon oxide, aluminum oxide, silicon nitride, aluminum nitride, titanium oxide, titanium nitride, zirconium oxide and zirconium nitride or a combination thereof. In an aspect, the structural support component of the supported membrane is a microporous material or a nanostructured material. In an another aspect, the thickness of the supported membrane separator is selected over the range of 1 μm to 100 μm, preferably over the range of 2 μm to 70 μm, more preferably over the range of 5 μm to 50 μm.

In an aspect of the invention, the active positive electrode material of the positive electrode is a fluroorganic material, a fluoropolymer, SOCl₂, SO₂, SO₂Cl₂, M1Xₚ,H₂O, O₂, MnO₂, CFₓ, NiOOH, Ag₂O, AgO, FeS₂, CuO, AgV₂O_{5.5}, H₂O₂, M1M2_{y}(PO₄)_{z} or M1M2_{y}Oₓ; wherein M1 is the electron donor metal; M2 is a transition metal or combination of transition metals; X is F, Cl, Br, I, or mixture thereof; p is greater than or equal to 3 and less than or equal to 6; y is greater than 0 and less than or equal to 2; x is greater than or equal to 1 and less than or equal to 4; and z is greater than or equal to 1 and less than or equal to 3. Suitable active positive electrode materials are known in the art, for example in U.S. Application Publication No. 2008/0280191, published Nov. 13, 2008 to Yazami et al., which is hereby incorporated by reference in its entirety.

In an embodiment, the invention provides an electrochemical generator comprising: a negative soluble electrode comprising: an electron donor comprising an electron donor metal provided in a first solvent, wherein the electron donor metal is an alkali metal, an alkali earth metal, a lanthanide metal or alloy thereof; an electron acceptor provided in the first solvent; wherein the electron acceptor is a polycyclic aromatic hydrocarbon or an organo radical; a first supporting electrolyte comprising a metal at least partially dissolved in the first solvent; wherein at least a portion of the electron donor comprising an electron donor metal is dissolved in the first solvent, thereby generating electron donor metal ions and solvated electrons in the first solvent; a positive electrode comprising: an active positive electrode material provided in contact with a second solvent; a second supporting electrolyte comprising a metal at least partially dissolved in the second solvent; and a separator provided between the negative soluble electrode and the positive electrode, wherein the separator is non-liquid and conducts the electron donor metal ions as a charge carrier in the electrochemical generator.

In an aspect of this embodiment, the supporting electrolyte comprises MXₙ, MO_{q}, MY_{q}, or M(R)ₙ; wherein M is a metal; X is —F, —Cl, —Br, or —I; Y is —S, —Se, or —Te; R is a group corresponding to a carboxylate group, alcohoate, alkoxide, ether oxide, acetate, formate, or carbonate; n is 1, 2, or 3; and q is greater than 0.3 and less than 3. In an aspect of this embodiment, the second solvent is water. In an aspect of this embodiment, the positive electrode further comprises a current collector provided in contact with the second solvent. In an aspect of this embodiment, the current collector comprises porous carbon, a nickel metal grid, a nickel metal mesh, a nickel metal foam, a copper metal grid, a copper metal mesh, a copper metal foam, a titanium metal grid, a titanium metal mesh, a titanium metal foam, a molybdenum metal grid, a molybdenum metal mesh, or a molybdenum metal foam. In an aspect of this embodiment, the soluble negative electrode further comprises a current collector provided in contact with the first solvent. In an aspect of this embodiment, the current collector comprises porous carbon, a nickel metal grid, a nickel metal mesh, a nickel metal foam, a copper metal grid, a copper metal mesh, a copper metal foam, a titanium metal grid, a titanium metal mesh, a titanium metal foam, a molybdenum metal grid, a molybdenum metal mesh, or a molybdenum metal foam. In an aspect of this embodiment, the electrochemical generator further comprises a source of the electron donor, the electron acceptor or the first solvent operationally connected to the first solvent. In an aspect of this embodiment, the electrochemical generator further comprises a source of the active positive electrode material, the second supporting electrolyte or the second solvent operationally connected to the second solvent. In an aspect of this embodiment, the electron donor metal is lithium, the electron acceptor is naphthalene, the first solvent is tetrahydrofuran, the separator is a ceramic, and the active positive electrode material of the positive electrode is O₂. In an aspect of this embodiment, the electron donor metal is lithium, the electron acceptor is biphenyl, the first solvent is tetrahydrofuran, the separator is a ceramic, and the active positive electrode material of the positive electrode is MnO₂.

The invention provides a range of electrochemical systems and generators. In an embodiment, the electrochemical generator of the invention is an electrochemical cell, such as a primary battery or a secondary battery. In an embodiment, the electrochemical generator of the invention is a fuel cell or a flow cell, optionally having a negative and/or positive electrode capable of being replenished. Flow cells and fuel cells are known in the art, for example in “Handbook of Batteries”, third edition, McGraw-Hill Professional, 2001, which is hereby incorporated by reference in its entirety to the extent not inconsistent with the present description.

In an embodiment of the invention, the invention provides a method of discharging an electrochemical generator, the method comprising: providing an electrochemical generator, the generator comprising: a negative soluble electrode comprising: an electron donor comprising an electron donor metal provided in a solvent, wherein the electron donor metal is an alkali metal, an alkali earth metal, a lanthanide metal or alloy thereof; an electron acceptor provided in the solvent; wherein the electron acceptor is a polycyclic aromatic hydrocarbon or an organo radical; wherein at least a portion of the electron donor comprising an electron donor metal is dissolved in the solvent, thereby generating electron donor metal ions and solvated electrons in the solvent; a positive electrode comprising an active positive electrode material; a separator provided between the negative soluble electrode and the positive electrode, wherein the separator is non-liquid and conducts the electron donor metal ions as a charge carrier in the electrochemical generator; and discharging the electrochemical generator.

In an embodiment of the invention, the invention provides a method of charging an electrochemical generator, the method comprising: providing an electrochemical generator, the generator comprising: a negative soluble electrode comprising: an electron donor comprising an electron donor metal provided in a solvent, wherein the electron donor metal is an alkali metal, an alkali earth metal, a lanthanide metal or alloy thereof; an electron acceptor provided in the solvent; wherein the electron acceptor is a polycyclic aromatic hydrocarbon or an organo radical; wherein at least a portion of the electron donor comprising an electron donor metal is dissolved in the solvent, thereby generating electron donor metal ions and solvated electrons in the solvent; a positive electrode comprising an active positive electrode material; a separator provided between the negative soluble electrode and the positive electrode, wherein the separator is non-liquid and conducts the electron donor metal ions as a charge carrier in the electrochemical generator; selecting a charging voltage and/or current according to a state of health of the electrochemical generator; and providing the selected voltage and/or current to the electrodes of the electrochemical generator to charge the electrochemical generator. Alternatively, the separator component of the present invention can be an anion conductor, a cation conductor, or an anion and cation mixed conductor.

In an aspect of this embodiment, the voltage and/or current provided to the electrochemical generator is preselected according to the number of charge/discharges cycles the electrochemical generator has experienced.

In an embodiment of the invention, the invention provides a method of charging an electrochemical generator, the method comprising: providing an electrochemical generator, the generator comprising: a negative soluble electrode comprising: an electron donor comprising an electron donor metal provided in a solvent, wherein the electron donor metal is an alkali metal, an alkali earth metal, a lanthanide metal or alloy thereof; an electron acceptor provided in the solvent; wherein the electron acceptor is a polycyclic aromatic hydrocarbon or an organo radical; wherein at least a portion of the electron donor comprising an electron donor metal is dissolved in the solvent, thereby generating electron donor metal ions and solvated electrons in the solvent; a positive electrode comprising an active positive electrode material; a separator provided between the negative soluble electrode and the positive electrode, wherein the separator is non-liquid and conducts the electron donor metal ions as a charge carrier in the electrochemical generator; removing substantially all of the electron donor metal, electron acceptor and first solvent from the soluble negative electrode; and providing electron donor metal, electron acceptor and first solvent to the soluble negative electrode.

Without wishing to be bound by any particular theory, there can be discussion herein of beliefs or understandings of underlying principles or mechanisms relating to the invention. It is recognized that regardless of the ultimate correctness of any explanation or hypothesis, an embodiment of the invention can nonetheless be operative and useful.

### BRIEF DESCRIPTION OF THE FIGURES

FIG. 1 provides a schematic of a cell design of an aspect of the present invention.

FIG. 2 provides a plot showing linear voltammetry (OCV→1 V, at 0.005 mV/s) for a soluble lithium liquid anode and MnO₂ cathode cell.

FIG. 3 provides a plot showing the discharge for a soluble liquid anode and MnO₂ cathode cell.

FIG. 4 provides a plot showing cyclic voltammetry (0 V [symbol] 0.645 V [symbol] >1.29 V, at 0.035 mV/s) for a lithium metal anode and soluble lithium in biphenyl electrode cell.

FIG. 5 provides a plot showing cyclic voltammetry (0 V [symbol] 0.72 V [symbol] 1.44 V, 0.035 mV/s) for a lithium metal anode and soluble lithium in naphthalene cathode cell.

FIG. 6 provides a linear voltammetry plot (OCV→4.4 V, 0.172 mV/s) showing the first voltammetric charge for a liquid lithium in biphenyl anode and LiNi_{1/3}Mn_{1/3}CO_{1/3}O₂ cathode cell.

FIG. 7 provides a plot showing cyclic voltammetry (1-4 V) for a soluble lithium in naphthalene anode and LiNi_{1/3}Mn_{1/3}Co_{1/3}O₂ cathode cell.

FIG. 8 provides a plot showing cyclic voltammetry (1-2 V) for a soluble lithium in naphthalene anode and LiNi_{1/3}Mn_{1/3}Co_{1/3}O₂ cathode cell.

FIG. 9 provides a plot showing linear voltammetry (OCV→1V, 0.005 mV/s) for a soluble lithium in biphenyl anode and MnO₂ cathode cell.

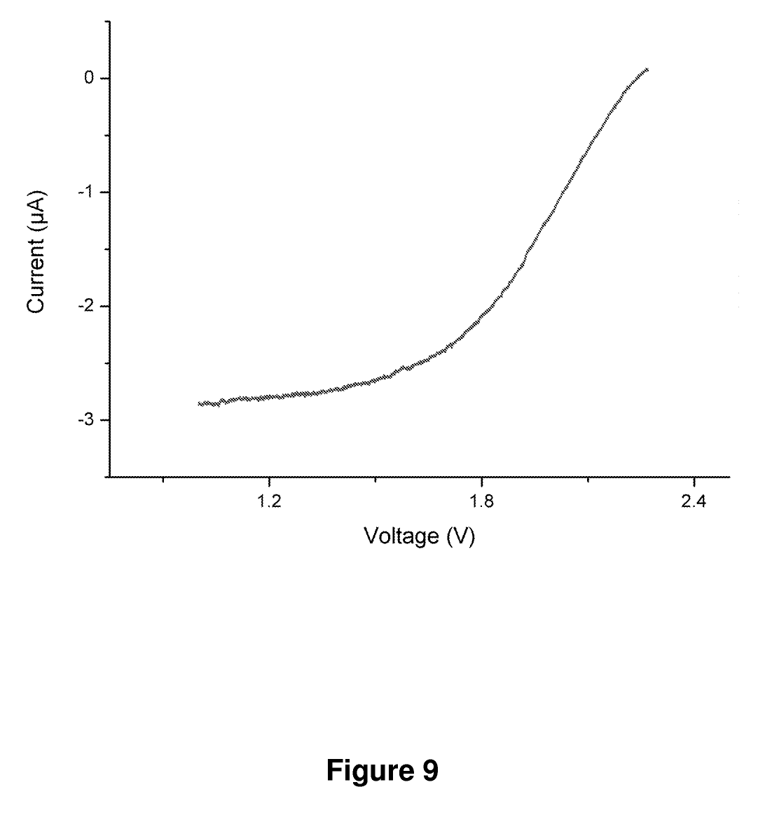

FIG. 10 provides a plot showing the discharge of a soluble lithium in biphenyl anode and MnO₂ cathode cell.

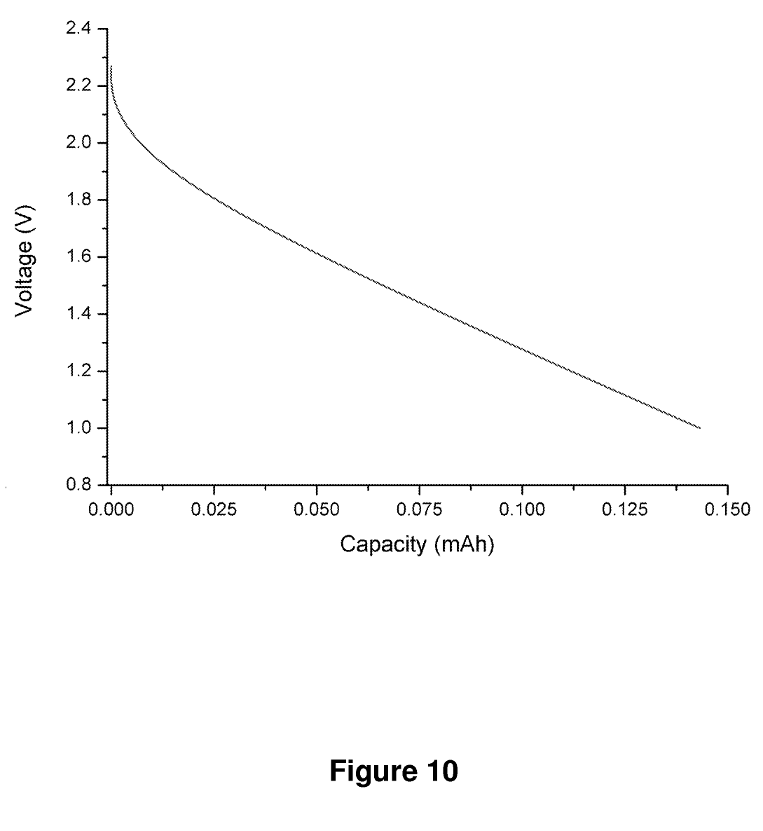

FIG. 11 provides x-ray diffractograms of MnO₂ cathodes. Trace A is an x-ray diffractogram taken after the first cell discharge of a cell employing a soluble lithium in biphenyl anode. Trace B is an x-ray diffractogram taken after discharge in a classic coin cell. Trace C is an x-ray diffractogram taken before discharge.

FIG. 12 provides a schematic of a regenerative flow cell embodiment of the invention.

FIG. 13 provides an SEM image of an air cathode. Carbon composite is impregnated in/on the Ni foam.

FIG. 14 provides a schematic of a test electrochemical cell used to test the effect of additives to the cathode liquid solution and emulsion on the oxygen dissolution in cathode designs described herein.

### DETAILED DESCRIPTION

Referring to the drawings, like numerals indicate like elements and the same number appearing in more than one drawing refers to the same element. In general the terms and phrases used herein have their art-recognized meaning, which can be found by reference to standard texts, journal references and contexts known to those skilled in the art. The following definitions are provided to clarify their specific use in the context of the invention.

The term “fluorinated” refers to a compound or species which contains carbon-fluorine bonds, such as organofluorine compounds and fluoroalkanes. The term “fluorinated carbon material” refers to a material having a general formula of CFₓ where 0.01<x<2, optionally provided in a solid state.

The term “fluorinated blood substitute” refers to a fluorocarbon (FC) of general formula CₙFₘ, where n is an integer from 1 to 20 and m is an integer from 2 to 42. The term “fluorinated blood substitute” also refers to a hydrofluorocarbon of general formula CₙFₚH_{q} where n is an integer from 1 to 20, p is an integer from 2 to 41, and q is an integer from 2 to 41. As the term is used in the present description, “fluorinated blood substitutes” need not be a compound which is used, or proposed to be used, as a blood substitute.

The term “metalloprotein” refers to a protein that contains a metal ion cofactor. Metalloproteins include, but are not limited to, hemoglobin, myoglobin, hemerythrin, and hemocyanins.

The term “oxygen dissolution enhancer” refers to a species which increases the dissolution of oxygen in a solvent. Oxygen dissolution enhancers described herein act to increase the concentration of oxygen available in a solvent for oxidation and/or reduction reactions. Optionally, “oxygen dissolution enhancers” can also act as metal oxide dissolution enhancers.

The term “metal oxide” refers to a chemical compound comprising at least one oxygen atom and at least one metal atom. Metal oxides described herein include, but are not limited to, metal oxides having the formula M_{y}Oₓ, wherein M is an electron donor metal, y is 1, 2 or 3 and x is 1, 2, 3 or 4.

The term “metal oxide dissolution enhancer” refers to a species which increases the dissolution of metal oxide in a solvent. Metal oxide dissolution enhancers described herein act to increase the concentration of metal oxides in a solvent and can act to decrease the amount of solid metal oxide on or in a current collector. Optionally, “metal oxide dissolution enhancers” can also act as oxygen dissolution enhancers.

The term “electron donor metal” refers to a metal which transfers one or more electrons to another. Electron donor metals of the present invention include, but are not limited to, alkali metals, alkali earth metals, and lanthanide metals (also known as lanthanoid metals). Electron donor metals of the present invention also include, but are not limited to boron, aluminum, gallium, indium and metalloids, such as germanium, silicon, and carbon. The species to which the electron donor metal donates an electron is referred to as an “electron acceptor”. Electron donor metals and electron acceptors may combine to form solvated electron solutions and can be used to form a soluble electrode for use in an electrochemical generator.

The term “polycyclic aromatic hydrocarbon” (abbreviated “PAH”) refers to a compound which contains two or more aromatic rings. Polycyclic aromatic hydrocarbons can act as electron acceptors. Polycyclic aromatic hydrocarbons can include heterocyclic rings and heteroatom substitutions. Polycyclic aromatic hydrocarbons include, but are not limited to, Azulene, Naphthalene, 1-Methylnaphthalene, Acenaphthene, Acenaphthylene, Anthracene, Fluorene, Phenalene, Phenanthrene, Benzo[a]anthracene, Benzo[a]phenanthrene, Chrysene, Fluoranthene, Pyrene, Tetracene, Triphenylene Anthanthrene, Benzopyrene, Benzo[a]pyrene, Benzo[e]fluoranthene, Benzo[ghi]perylene, Benzo[j]fluoranthene, Benzo[k]fluoranthene, Corannulene, Coronene, Dicoronylene, Helicene, Heptacene, Hexacene, Ovalene, Pentacene, Picene, Perylene, and Tetraphenylene.

The term “organo radical” refers to an organic molecule having an unpaired electron. Organo radicals can be provided to a solution or a solvent in the form of a halide analogue of the organo radical. Organo radicals include alkyl radicals which can be provided to a solution or solvent as an alkyl halide. Organo radicals can react via a charge transfer, partial electron transfer, or full electron transfer reaction with an electron donor metal to form an organometallic reagent. Organo radicals can act as electron acceptors. The term “organometallic reagent” refers to a compound with one or more direct bonds between a carbon atom and an electron donor metal. Organo radicals include, but are not limited to, butyl and acetyl radicals.

The term “solvent” refers to a liquid, solid, or gas that dissolves a solid, liquid, or gaseous solute, resulting in a solution. Liquid solvents can dissolve electron acceptors (such as polycyclic aromatic hydrocarbons) and electron donor metals in order to facilitate the transfer of electrons from the electron donor metal to the electron acceptor. Solvents are particularly useful in soluble electrodes of the present invention for dissolving electron donor metals and electron acceptors to form electron donor metal ions and solvated electrons in the solvent. Solvents include “organic solvents” which are solvents comprising organic molecules.

The term “electrode” refers to an electrical conductor where ions and electrons are exchanged with electrolyte and an outer circuit. “Positive electrode” and “cathode” are used synonymously in the present description and refer to the electrode having the higher electrode potential in an electrochemical cell (i.e. higher than the negative electrode). “Negative electrode” and “anode” are used synonymously in the present description and refer to the electrode having the lower electrode potential in an electrochemical cell (i.e. lower than the positive electrode). Cathodic reduction refers to a gain of electron(s) of a chemical species, and anodic oxidation refers to the loss of electron(s) of a chemical species. The terms negative electrode and anode can refer to an electrode and/or to a component of an electrode which participates in oxidation and/or reduction of a charge carrier species during charging and/or discharging of an electrochemical generator. Positive and negative electrodes of the present invention can be provided in a range of useful configurations and form factors as known in the art of electrochemistry and battery science, including thin electrode designs, such as thin film electrode configurations. Electrodes are manufactured as disclosed herein and as known in the art, including as disclosed in, for example, U.S. Pat. Nos. 4,052,539, 6,306,540, 6,852,446, each of which is hereby incorporated by reference in their entireties.

The term “active positive electrode material” or “cathode” refers to a component of a positive electrode which participates in oxidation and/or reduction of a charge carrier species during electrical charging and/or electrical discharging of an electrochemical generator. The term “active negative electrode material” or “anode” refers to a component of a negative electrode which participates in oxidation and/or reduction of a charge carrier species during electrical charging and/or electrical discharging of an electrochemical generator.

The term “solvated electron” refers to a free electron which is solvated in a solution. Solvated electrons are not bound to a solvent or solute molecule, rather they occupy spaces between the solvent and/or solute molecules. Solutions containing a solvated electron can have a blue, bronze or green color, due to the presence of the solvated electron. Soluble electrodes comprising a solvated electron solution allow for significantly increased energy density, specific power, and specific energy when compared with state of the art commercial lithium ion based batteries.

The term “soluble electrode” refers to an electrode in which the chemical species involved in oxidation and/or reduction are provided, at least in part, in liquid form. Soluble electrodes can contain elements which do not participate in oxidation or reduction such as electrolytes, supporting electrolytes, dissolution enhancers, current collectors and solvents.

The term “electrochemical generator” refers to devices which convert chemical energy into electrical energy and also includes devices which convert electrical energy into chemical energy. Electrochemical generators include, but are not limited to, electrochemical cells, primary electrochemical cells, secondary electrochemical cells, electrolysis devices, flow cells and fuel cells. The term “primary cell” refers to an electrochemical generator in which the electrochemical reaction is not reversible. The term “secondary cell” refers to an electrochemical cell in which the electrochemical reaction is reversible. The term “flow cell” refers to a system where the active electrode materials are introduced into their respective compartments from an external reservoir/container either by a continuous circulation or by an intermittent regenerative process. General electrochemical generator, cell and/or battery construction is known in the art, see e.g., U.S. Pat. Nos. 6,489,055, 4,052,539, 6,306,540, and Seel and Dahn J., Electrochem. Soc. 147(3) 892-898 (2000), each of which is hereby incorporated by reference in their entireties.

The term “electrolyte” refers to an ionic conductor which can be in the solid state, the liquid state or more rarely a gas (e.g., plasma). The term “non-liquid electrolyte” refers to an ionic conductor provided in the solid state. Non-liquid electrolytes include ionic conductors provided as a gel. The term “supporting electrolyte” refers to an electrolyte whose constituents are not electroactive during charging or discharging of the electrode or electrochemical generator which comprises the supporting electrolyte. The ionic strength of a supporting electrolyte can be much larger than the concentration of an electroactive substance in contact with the supporting electrolyte. Electrolytes can comprise a metal salt. The term “metal salt” refers to an ionic species which comprises a metal cation and one or more counter anions such that the metal salt has a net charge of zero. Metal salts can be formed by the reaction of a metal with an acid.

The terms “reducing agent” and “reduction agent” are synonymous and refer to a material which reacts with a second material and causes the second material to gain electron(s) and/or decreases the oxidation state of the second material. The terms “oxidation agent” and “oxidizing agent” are synonymous and refer to a material which reacts with a second material and causes the second material to lose electron(s) and/or increases the oxidation state of the second material. Oxidizing agents can also be electron acceptors and reducing agents can also be electron donors.

The terms “charge” and “charging” refer to the process of increasing the electrochemical potential energy of an electrochemical generator. The term “electrical charging” refers to the process of increasing the electrochemical energy in an electrochemical generator by providing electrical energy to the electrochemical generator. Charging can take place by replacing depleted active electrochemical materials of an electrochemical generator with new active compounds or by adding new active materials to the electrochemical generator.

The term “state of health” refers to the relative amount of electrochemical energy available upon discharge in an electrochemical generator when compared to a reference electrochemical generator with the same or similar components under the same or similar conditions. The first electrochemical generator can have a reduced amount of electrochemical energy available upon discharge when compared to the reference electrochemical generator due to undergoing multiple charge/discharge cycles which the reference electrochemical generator which has not undergone.

The term “separator” refers to a non-liquid material that physically separates a first electrode from a second electrode in an electrochemical cell. Separators can act as electrolytes and can be metal ion conductors, anion conductors or cation and anion mixed conductors. Separators can also act as electrical insulators and can have very low electrical conductivities. For example, separators can have electrical conductivities less than 10⁻¹⁵ S/cm.

### Example 1

### Liquid Alkali Metal Anode Cells

### Principle

Alkali metals (AM) and other electron donor metal ions form solvated electron (SE) solutions with a variety of molecules, including polycyclic aromatic hydrocarbons (PAHs) such as naphthalene and organo radicals such as alkyl radicals. Many polycyclic aromatic hydrocarbons are solid at room temperature and, therefore, can be provided dissolved in a suitable solvent. Solvated electron complexes can be formed by dissolving the electron donor metal in a polycyclic aromatic hydrocarbon solution such as naphthalene in tetrahydrofuran. The solution takes a green-blue color characteristic of solvated electron complexes.

We used AM-PAH based solvated electron solutions as a working liquid anode for battery applications. The active cathode material in these systems can be as simple as air, water, MnO₂ or more complex, such as LiMn_{1/3}Ni_{1/3}Co_{1/3}O₂ (LMNCO). The electrochemistry for cells having a soluble alkali metal in polycyclic aromatic hydrocarbon anode is provided below:

Alkali metal dissolution:

AM+nPAH→AM⁺+(e⁻,nPAH)⁻ (1)

Anode reaction (discharge):

(e⁻,nPAH)⁻→nPAH+e⁻ (2)

Cathode reaction (in case of air):

O₂+2AM⁺+2e⁻→(AM)₂O₂ (3)

Total discharge reaction for an alkali metal solvated electron anode and air cathode battery:

2AM⁺+2(e⁻,nPAH)⁻+O₂→(AM)₂O₂+2 nPAH (4)

### Experimental and Results

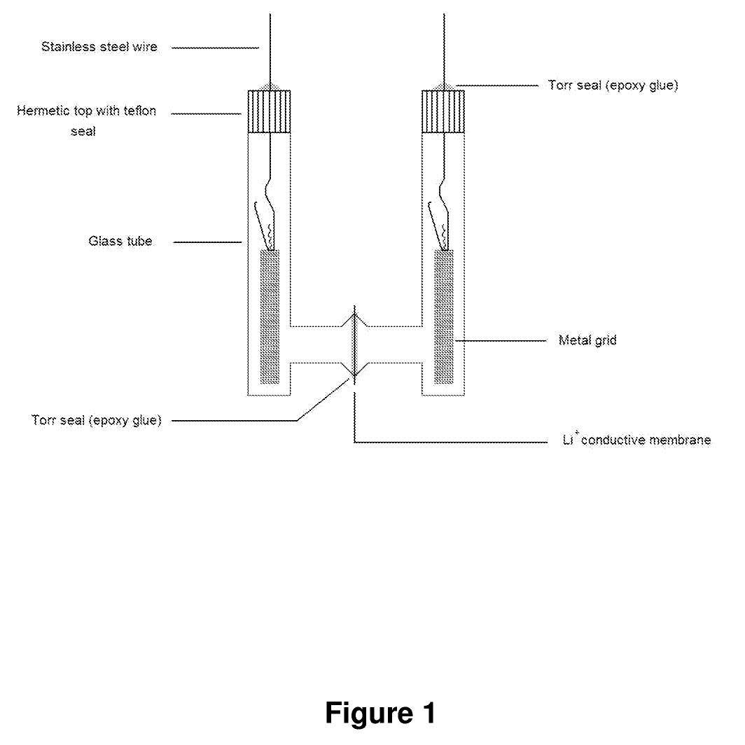

The experimental cell used to conduct experiments is shown in FIG. 1. The experimental cell includes two glass tubes separated by a Li⁺ conductive membrane held together with epoxy glue (Torr seal). The glass tubes are sealed at the top by hermetic Teflon seals. A metal grid is provided as a current collector to each tube. Stainless steel wires are connected to the current collectors and pass through the hermetic Teflon seal at the tops of the glass tubes and held in place by an epoxy glue (Torr seal).

The open circuit voltages of two cells were measured using a multimeter. The first cell was a lithium metal and naphthalene liquid anode with an air in water cathode. The open circuit voltage of this cell was measured as 2.463 V. The second cell was a lithium metal and naphthalene liquid anode with a MnO₂ in propylene carbonate cathode. The open circuit voltage of this cell was measured as 2.312 V.

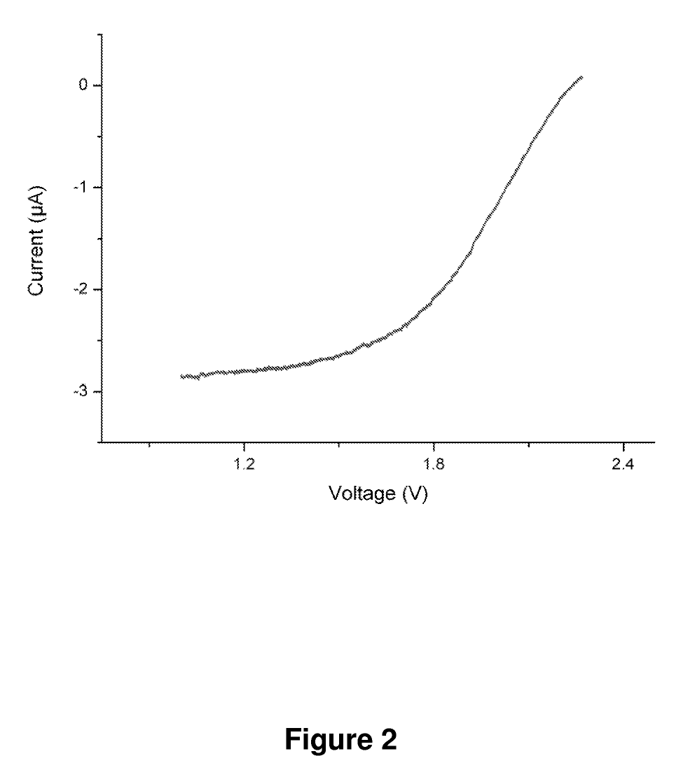

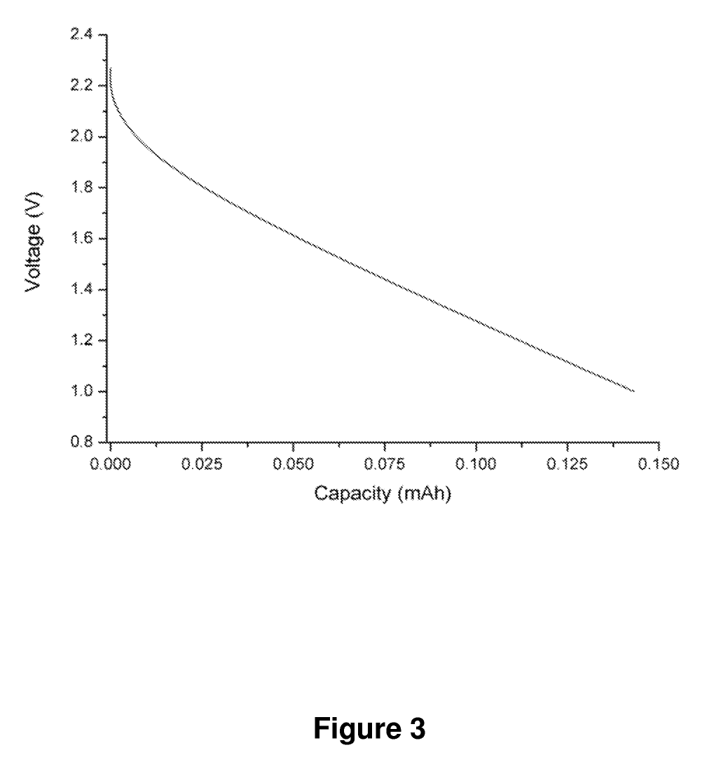

The linear voltammetry of the lithium metal in naphthalene liquid anode and MnO₂ in propylene carbonate cathode cell was measured from the open current voltage to one volt above the open circuit voltage at 0.005 mV/s. The results are shown in FIG. 2. The discharge of the same cell was measured and is shown in FIG. 3. These results show that a cell with an alkali metal and polycyclic aromatic hydrocarbon soluble anode produces enough free electrons and lithium metal ions in the anode such that significant charging and discharging of the cell is achieved.

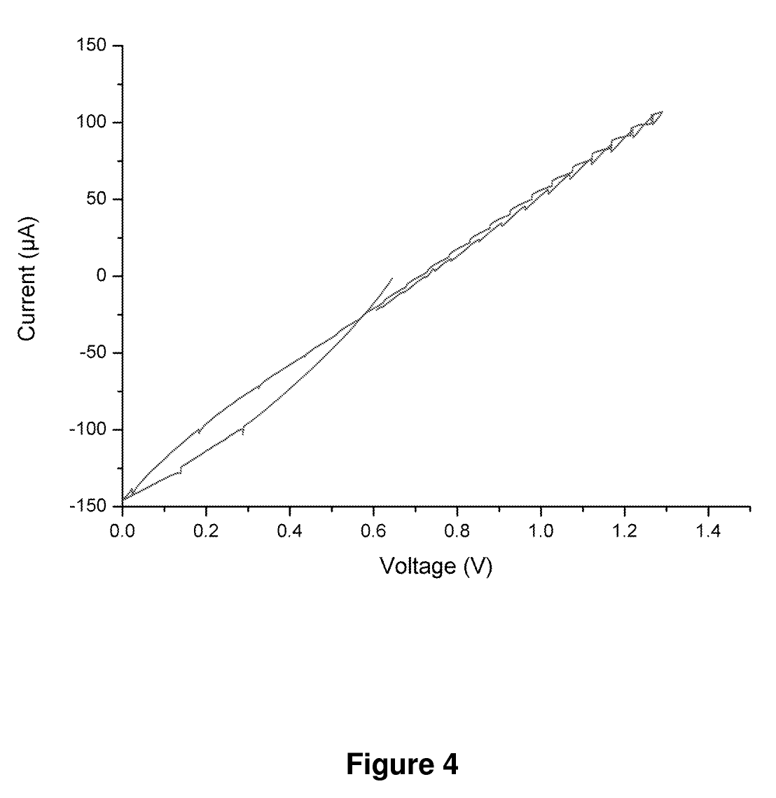

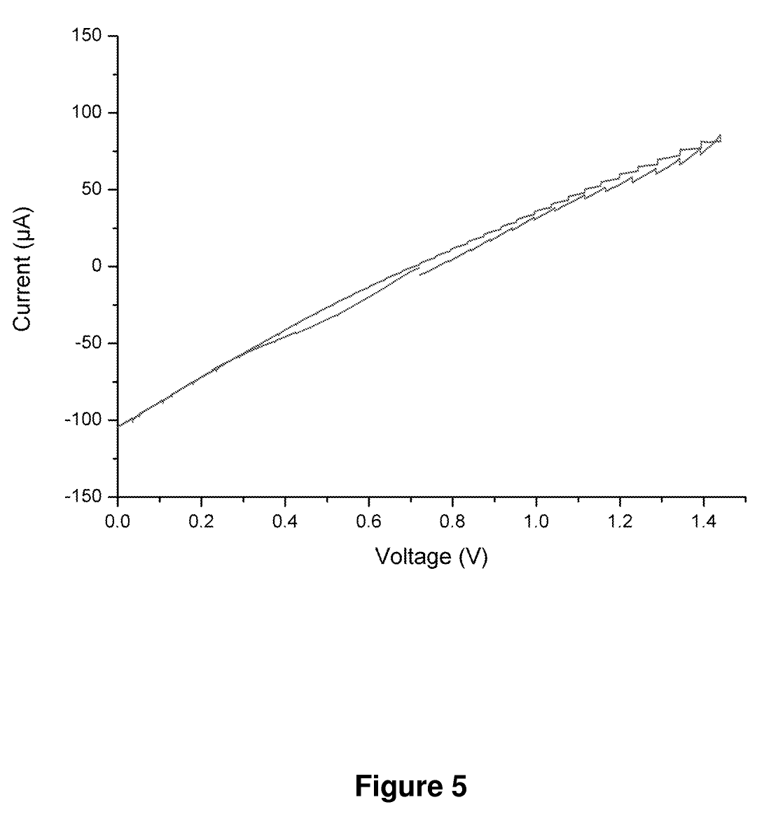

A lithium metal reference electrode and lithium in biphenyl soluble electrode of the half cell was constructed and cyclic voltammetry from the open circuit voltage through 0.645 V to 1.29 V was measured at 0.035 mV/s. The results are shown in FIG. 4. A lithium metal reference electrode and lithium in naphthalene soluble electrode half cell was constructed and the cyclic voltammetry from the open circuit voltage through 0.72 V to 1.44 V was measured at 0.035 mV/s. The results are shown in FIG. 5. These cyclic voltammetry experiments show that the alkali metal and polycyclic aromatic hydrocarbon can act as a soluble electrode in a rechargeable battery system.

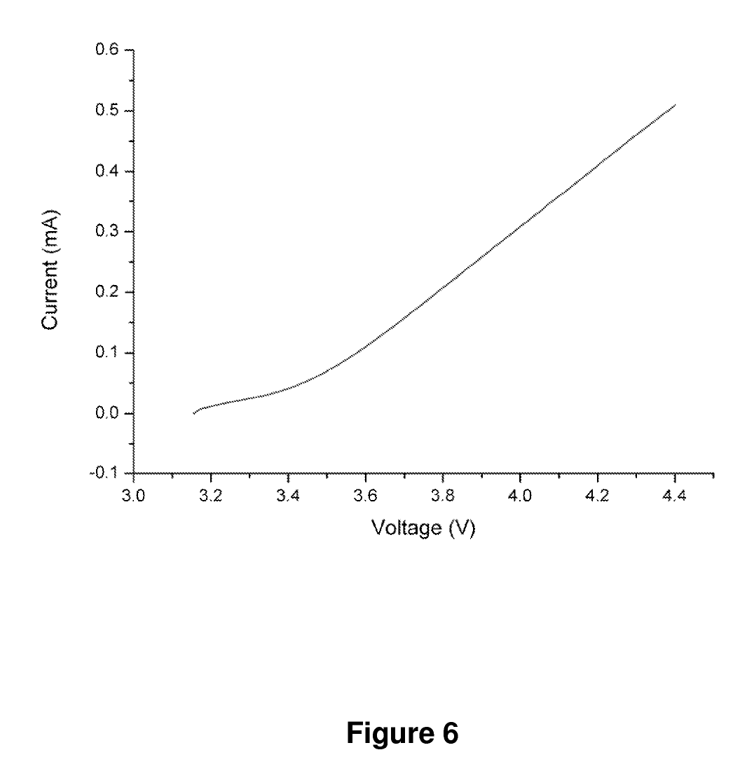

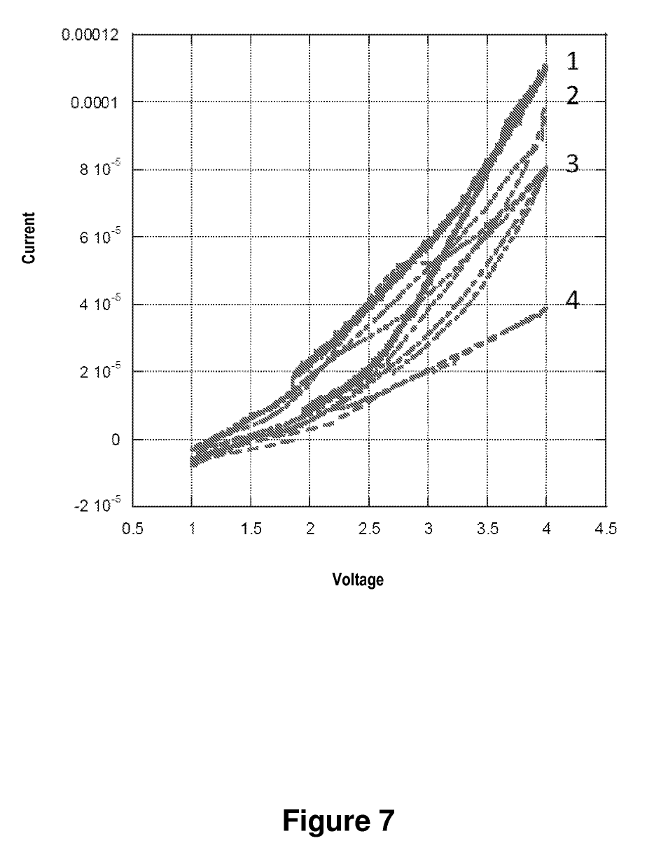

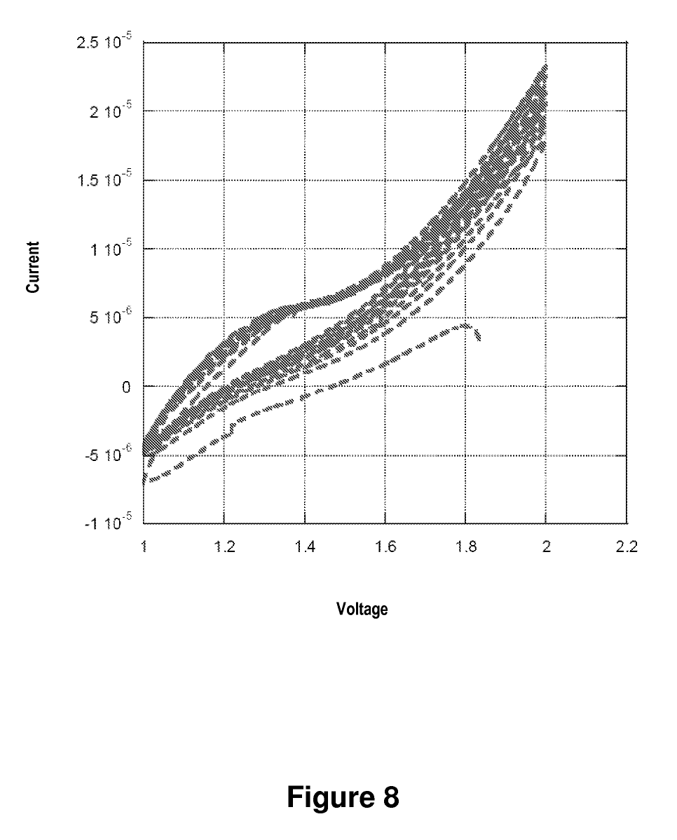

A lithium in naphthalene soluble anode and LiNi_{1/3}Mn_{1/3}Co_{1/3}O₂ cathode cell was constructed. The linear voltammetry of this cell was measured from the open circuit voltage to 4.4 V at 0.172 mV/s. The results are shown in FIG. 6. Note that this charging curve is nearly linear from between about 3.2 V to about 4.4 V. The cyclic voltammetry from 1 to 4 volts for the same cell was measured and the results are shown in FIG. 7. The cyclic voltammetry for this cell was also measured between 1 and 2 volts and is shown in FIG. 8.

### Example 2

### Realization of a Liquid Lithium Anode Cell

### Principle

It is known that lithium can be dissolved in solutions containing polycyclic aromatic hydrocarbons such as naphthalene or biphenyl due to the high electron affinity of the polycyclic aromatic hydrocarbons. The reaction forming solvated electrons for both biphenyl and naphthalene are shown in eq. 12 and 13, below. Such lithium solutions, however, are not used in commercial electrochemistry applications because of their extreme reactive character and also the lack of useful resistant membranes which both separate the solvated electron solution from the cathode while at the same time allowing transfer of metal ions between the solvated electron solution and the cathode in a separate compartment.

2Li₍ₘₑₜₐₗ₎+biphenyl→[2Li⁺, (2e⁻, biphenyl)] (eq. 12)

2Li₍ₘₑₜₐₗ₎+naphthalene→[2Li⁺, (2e⁻, naphthalene)] (eq. 13)

Ohara Corporation has recently developed, and we have obtained, a new Lithium-Ion Conducting Glass-Ceramic (LIC-GC) membrane. This separator possesses one of the highest Li-ion conductivity values for a solid electrolyte (on the order of 1×10⁻⁴ S·cm⁻¹ at 25° C.), outstanding chemical resistance properties and excellent physical and mechanical properties with a 150 μm thickness. These attributes make the membrane extremely useful in an electrochemical generator as a separator and electrolyte. After some tests, we confirmed that the membrane is liquid lithium solution resistant. Indeed, we used it to build a very innovative battery with a liquid lithium anode.

### Experimental

A cell was designed to run experiments to prove that liquid lithium solutions can be successfully employed as a soluble anode in an electrochemical generator. The cell is composed of two glass compartments separated by the Li⁺ conductive membrane (FIG. 1). Two similar models of this cell were made.

Four types of liquid lithium solutions were used as the soluble anode for these investigations (all molar in each constituent): THF/Biphenyl/LiI/Li₍ₛ₎, THF/Naphthalene/LiI/Li₍ₛ₎, THF/Biphenyl/LiCl/Li₍ₛ₎, and THF/Naphthalene/LiCl/Li₍ₛ₎. In these solutions, the polycyclic aromatic hydrocarbon (naphthalene or biphenyl) is dissolved in tetrahydrofuran (THF). Lithium metal is added to this solution and the lithium donates an electron to the solution, thus forming lithium ions and solvated electrons in the solution. The LiCl and LiI salts are added to the solution as an electrolyte to increase the conductivity of the solution.

20 ml of each solution were prepared under argon in a glove box. LiI and LiCl were added as a source of Li⁺. Note that Li₍ₛ₎ is totally soluble in both naphthalene and biphenyl solutions because one mole of each compound can dissolve two moles per liter of Li₍ₛ₎. Also, note that LiCl is not soluble up to 1M in THF. All solutions have a dark blue color due to the presence of solvated electrons.

After we made sure that liquid lithium solutions did not react with the membrane, Torr seal or metal grid, four kinds of tests were carried out:

First test: To prove that the principle works experimentally, a cell was constructed of a liquid lithium in biphenyl anode solution and a MnO₂ cathode recovered from a classic Li/MnO₂ coin cell. The cell reaction is shown in eq. 14.

[Li⁺, (e⁻, biphenyl)]+MnO₂→LiMnO₂+biphenyl (eq. 14)

Reverse test: To verify that Li ion can circulate from the anode to the cathode and from the cathode to the anode, batteries composed of a metal lithium anode and a liquid lithium cathode were made (see eq. 15).

(biphenyl or naphthalene)+Li₍ₘₑₜₐₗ₎ [symbol] [Li⁺, (e⁻, biphenyl or naphthalene)] (eq. 15)

Color test: To confirm that Li ion can totally be transferred between the anode and cathode, cells made up of a liquid lithium anode and only THF/LiX/naphthalene or biphenyl (X═I or Cl) as cathode (see eq. 16).

[Li⁺, (e⁻, biphenyl or naphthalene)]+(biphenyl or naphthalene)_{cathode side}→(biphenyl or naphthalene)_{anode side}+[Li⁺, (e⁻, biphenyl or naphthalene)] (eq. 16)

Water test: To prove that this kind of battery can work with a cathode as simple as water, cells made up of a liquid lithium anode and a salt water cathode were prepared (see eq. 17).

[Li⁺, (e⁻, biphenyl or naphthalene)]+H₂O→1/2H₂+LiOH (eq. 17)

For each kind of test, several cells have been tested and improved by modifying some parameters or using different liquid lithium solutions as a comparison. Features of all these cells are detailed in Table 2, below.

TABLE 2
Experimental Cell Components, Experiments, and Open Current
Voltages (OCV)

| Name | | Metal grid | | Metal grid | | |
|---|---|---|---|---|---|---|
| of the | | (Anode | | (Cathode | Cell OCV | Electrochemical |
| cell | Anode | side) | Cathode | side) | (V) | experiments |
| First | 1M THF/ | Al | MnO2 in | Al | 2.281 | Linear |
| test | biphenyl/ | | 1M | | | voltammetry |
| | LiI/Li | | LiClO₄/PC | | | |
| Reverse | Metal | Al | 1M THF/ | Al | 0.700 | Cyclic |
| tests | Lithium in | | biphenyl/ | | | voltammetry |
| | 1M LiClO₄/ | | LiI/Li | | | |
| | PC | | | | | |
| | Metal | — | 1M THF/ | Al | 0.766 | Cyclic |
| | Lithium in | | biphenyl/ | | | voltammetry |
| | 1M LiBF₄/ | | LiI/Li | | | |
| | PC/DME | | | | | |
| | Metal | — | 1M THF/ | Cu foam | 0.645 | Cyclic |
| | Lithium in | | biphenyl/ | | | voltammetry |
| | 1M LiBF₄/ | | LiI/Li | | | |
| | PC/DME | | | | | |
| | Metal | — | 1M THF/ | Cu foam | 0.720 | Cyclic |
| | Lithium in | | naphthalene/ | | | voltammetry |
| | 1M LiBF₄/ | | LiI/Li | | | |
| | PC/DME | | | | | |
| Color | 1M THF/ | Cu foam | 1M THF/ | Cu foam | 1.200 | Linear |
| tests | naphthalene/ | | naphthalene/ | | | voltammetry |
| | LiI/Li | | LiI | | | and then |
| | | | | | | constant voltage |
| | | | | | | (−1.158 V) |
| | | | | | | during 3 days |
| | 1M THF/ | Cu foam | 1M THF/ | Cu foam | 1.103 | Constant |
| | naphthalene/ | | naphthalene/ | | | current (−3.51 mA) |
| | LiI/Li | | LiCl | | | during 24 h |
| | 1M THF/ | Cu foam | 1M THF/ | Cu foam | 2.177 | Constant |
| | naphthalene/ | | naphthalene/ | | | current (−3.51 mA) |
| | LiCl/ | | LiCl | | | during 24 h |
| | Li | | | | | |
| | 1M THF/ | Cu foam | 1M THF/ | Cu foam | 1.760 | Constant |
| | biphenyl/ | | biphenyl/ | | | current (−0.977 mA) |
| | LiCl/Li | | LiCl | | | during 96 h |
| Water | 1M THF/ | Cu foam | 1M H₂O/ | Ni | 2.6 | Linear |
| tests | naphthalene/ | | LiCl | | | voltammetry + |
| | LiI/Li | | | | | HCl addition |
| | | | | | | (cathode side) |
| | | | | | | at the end to |
| | | | | | | increase OCV |
| | | | | | | (2.19→2.62 V) |
| | 1M THF/ | Cu foam | 1M H₂O/ | Cu foam | 2.32 | Linear |
| | naphthalene/ | | LiCl | | | voltammetry |
| | LiCl/ | | | | | |
| | Li | | | | | |
| | 1M THF/ | Cu foam | 1M H₂O/ | Ni | 2.613 | Linear |
| | biphenyl/ | | LiCl | | | voltammetry |
| | LiCl/Li | | | | | |

Before being tested, each cell was carefully washed with acetone and dried in an oven at 100° C. The metal grid current collectors were also washed and dried in this manner. Cells were then filled in a glove box under argon atmosphere and removed to first record their open circuit voltage (OCV) and then to run electrochemical experiments. Electrochemical experiments carried out included linear and cyclic voltammetry (current recording versus applied potential gradient) to study discharge or investigate rechargeable capabilities of the cells. Voltammetry measurements were recorded on a voltalab PGZ 301 system. After several measurements, each cell was recycled by burning the Torr seal glue to remove the electrolyte membrane separator and separate both parts of the cell. Finally, a new cell was built with a new separator and use for further tests.

X-ray diffraction (XRD) analyses was also carried out on MnO₂ cathode samples before and after discharge (by linear voltammetry) of the first cell and compared to a MnO₂ cathode sample recovered after discharge of a classic coin cell with a Li metal anode and the MnO₂ cathode. XRD measurements were carried out on a Philips X'Pert Pro at 45 kV and 40 mA.

### Results—First Test

The current vs. voltage data obtained by linear voltammetry (FIG. 2) has been converted into a classic voltage vs. capacity discharge curve (FIG. 3). Capacity is calculated from the current vs. time curve by the following equation 18:

$$Q = {\int }_{t = 0}^{t} I ( t ) d t \qquad eq . 18$$

The linear voltammetry curve shows that a low discharge current passes through the cell when the applied potential was decreased, also current seems to reached a limit around −3 μA. The fact that we obtained such a low current can be explained by the very low voltage scan speed and also by the low membrane surface area (approximately 1 cm²). Indeed, a relatively low capacity is reached at the end of the voltammetry (around 0.143 mAh), as can be seen in FIG. 3. Moreover, the amount of Li⁺ which passes through the membrane to insert in MnO₂ can be calculated from the capacity value by the following equation 19:

$${n}_{L \cdot i} = \frac{0.143 \times 3.6}{96500} = 5.33 \times {10}^{- 6} mol \qquad eq . 19$$

To confirm that Li ion was effectively passed through the membrane to insert in MnO₂ structure to give LiMnO₂, we have carried out some XRD analyses of MnO₂ cathode before and after the discharge.

MnO₂-type which is used as a cathode in Li/MnO₂ primary batteries is γ-MnO₂. The γ-MnO₂ structure exhibits both Rutile with (1×1) channels and Ramsdelite with (2×1) channel domains. The (2×1) channels can accommodate Li⁺ ions far more readily than the (1×1) channels. At the end of a cell discharge, the hexagonal-close-packed oxygen lattice is substantially distorted by lithium insertion and ideally resembles an α-MnOOH-type structure (groutite). But in a fully lithiated γ-MnO₂ product it is unlikely that the hexagonally-close-packed oxygen array will remain stable due to electrostatic interactions between Li⁺ and the Jahn-Teller (d⁴) Mn³⁺ ions in face-shared octahedral configuration. It is therefore probable that the structure will be modified away from an ideal α-MnOOH-type structure to accommodate these interactions.

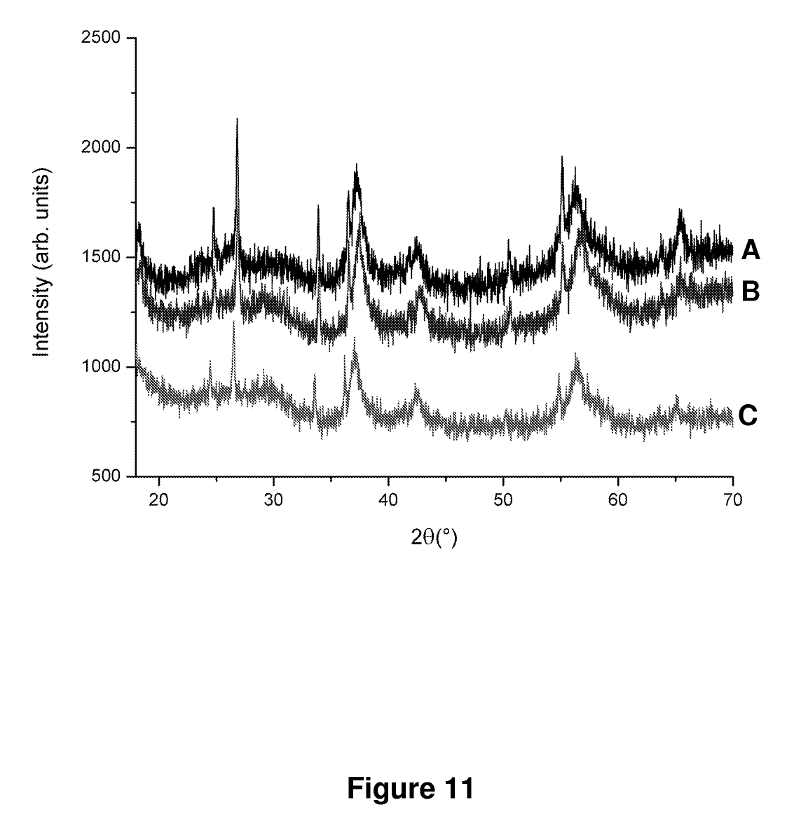

X-ray diffractograms of MnO₂ cathodes after both first cell and classic coin cell discharge are similar to the MnO₂ cathode XRD before discharge (FIG. 11). Indeed, they have certainly the same crystalline structure but nevertheless, both of the MnO₂ after discharge diffractograms traces are more similar than the one before discharge. Those results are consistent with the fact that only a small quantity of Li ion passed through the membrane to insert in the MnO₂ cathode which are indeed not at all fully lithiated at the end of the linear voltammetry.

### Results—Reverse Tests

Two cyclic voltammetry measurements, one with lithium naphthalide (naphthalene) solution (FIG. 5) and one with solution of lithium biphenyl (FIG. 4), have been carried out.

The first observation is that the OCV (open current voltage) of the cell made up with biphenyl is lower than the OCV of the cell made up with naphthalene. Indeed, reductive potential of the solution of lithium biphenyl is closer, to the one of metal lithium, than the one of lithium naphthalide. This is contrary to the fact that the biphenyl electron affinity is higher (0.705) than the naphthalene one (0.618) based on mₘ₊₁. The term mₘ₊₁ is the Hückel value of the coefficient of the molecular orbital resonance integral in the expression for the energy of the lowest unoccupied orbital of the arene. [Taken from A. Streitwieser, jun., “Molecular Orbital Theory for organic Chemists”, Wiley, New York, 1961, p 178.]

Aspects of both cyclic voltammetry curves show that both oxidation and reduction processes of the two electrodes is reversible, with only a small amount of hysteresis observed. An interesting jagged shape of the curve is obtained during both charge and discharge between the OCV and twice the OCV.

If we compare the two cyclic voltammetry curves, we can see that the only difference is that a higher current is reached when the solution of lithium biphenyl is used.

### Results—Water Test

For this test, cathode side compartment containing a solution of 1M H₂O/LiCl remained open because of the hydrogen gas formation during cell discharge. Good results haven't been obtained probably due to liquid lithium solution quality once again. Actually, after every experiment, the dark blue color of liquid lithium solutions changed to a milky one, that's mean Li was oxidized. First we thought that was a cell leak problem but after some tests it was actually a glove box problem because color of solutions started to change inside the latter. After those finding, the glove box was regenerated but we hadn't enough time and material (membranes) to run other test like this one.

Nevertheless, interesting results that we can find out of those experiments is that a relatively high OCV is available with these Li_{(liq)}/H₂O cells (around 2.6 V). Moreover, addition of HCl to water at the end of the discharge of those cells contributes to enhance the OCV (2.19→2.62 V) by increasing the H⁺ concentration.

### Results—Last Test

Several tests were performed after the regeneration of the glove box using a new liquid lithium solution (biphenyl) and a special cathode provide to us by ENAX, Co., Japan. The compound formula that composed this cathode is LiNi^{II}_{1/3}Co^{II}_{1/3}Mn^{I/V}_{1/3}O₂. The cathode is made of an aluminum foil enrobed by this compound. Features of this material allow making a rechargeable battery between 3.2 and 4.5 V (vs. Li metal). First result has shown an OCV of 3.16 V, very close to the one expected vs. Li metal. This means Li metal and liquid lithium solution potentials are closer than we have previously found. This is can be due to the higher quality of the liquid lithium solution prepared after the glove box regeneration. A linear voltammetry was carried out on this cell to charge it (FIG. 6). Results show that higher currents are available (around 500 μA) that had never been reached before. Finally, these last tests give the proof that liquid lithium solutions used for the previous tests were certainly a little bit oxidized and better results will surely be obtained for future experiments.

### Example 3

### A Hybrid Electrochemical Generator with a Soluble Anode

Since their commercialization in the early 1990s lithium ion batteries (LIBs) have become the dominant electrical power source in most portable electronics such as cellular phones and laptop computers and are tested in automobile applications such as in hybrid cars, plug-in hybrids and electrical vehicles. The obvious advantage of lithium ion batteries compared to other battery chemistries is a high energy density of over 200 Wh/kg more than twice that of alkaline batteries and five times that of lead acid batteries [1]. Theoretical (maximum) energy density of current LIBs is in the order of 450 Wh/kg. On the other hand, primary (non rechargeable) lithium batteries using polycarbon monofluoride as the cathode material (Li/CFx) have demonstrated up to 650 Wh/kg. Therefore a compromise in energy density has been set vs. rechargeability. Here we introduce a new chemistry that allows for rechargeability and high energy density. The chemistry is based on the soluble anode where the battery is no more recharged electrically but by feeding the anode and the already existing cathode with active materials like in fuel cells. The anode here is in the liquid state (solution), whereas all known commercial batteries use solid state anodes.

In an electrochemical power source the active materials involved in the anode, the cathode and the electrolyte composition can be found in the three states of matter; solid, liquid and gas. Current lithium batteries use a solid state cathode (positive pole) based on metal oxides or phosphates, a solid state anode (negative pole) based on metallic lithium (in primary cells) and lithiated carbon (in rechargeable cells) and a liquid state organic electrolyte. Both lithium and lithiated carbon anodes provide a high energy and a high power density. However, combining a solid state anode and an organic liquid electrolyte has been identified as the cause of the battery thermal runaway, which raises serious safety issues, especially in large size systems such as those considered for hybrid and electric cars application. Moreover, only electrical recharge is applicable to lithium ion batteries, which requires long times and limits the energy density to about 200 Wh/kg. The advantage of fuel cells vs. batteries resides in the fact that they can be fed with active materials from an external tank, which extends the loaded energy and reduces the “recharge” time. Polymer electrolyte membrane (PEM) fuel cells use gaseous hydrogen and methanol as the active anode materials and oxygen as the active cathode. The electrolyte is a solid state membrane. To operate PEMs requires expensive catalysts to be used on the carbon supported anode and cathode materials, yet the achieved power density is not high enough for transportation applications.

The table below (Table 3) summarizes the physical state of active electrode materials in some of the battery and fuel cells systems and introduces the new soluble anode technology.

TABLE 3
Physical State of Active Electrode Materials for Classic Batteries and
Fuel Cells and for the Soluble Anode Technology

| Electrochemical | Anode | | Cathode | | Electrolyte/Separator | |
|---|---|---|---|---|---|---|
| System | Material | State | Material | State | Material | State |

Present Technologies

| | | | | | | |
|---|---|---|---|---|---|---|
| Lithium Ion | Carbon | Solid | Metal Oxide | Solid | Organic | Liquid |
| Lithium-air | Lithium | Solid | Air | Gas | Ceramic | Solid |
| Lithium | | | | | | |
| Primary | | | | | | |
| Li/MnO₂ | Lithium | Solid | MnO₂ | Solid | Organic | Liquid |
| Li/SOCl₂ | Lithium | Solid | SOCl₂ | Liquid | Organic | Liquid |
| Fuel Cell | | | | | | |
| PEMFC | O₂ (air) | Gas | H₂ | Gas | Membrane | Solid |
| DMFC | O₂ (air) | Gas | Methanol | Liq./Gas | Membrane | Solid |

Soluble Anode Technology

| | | | | | | |
|---|---|---|---|---|---|---|
| Li-organic | Li-organic | Liquid | SOCl₂/SO₂ | Liquid | Ceramic/ | Solid |
| | | | | | Polymer | |
| Li- | Li-organic | Liquid | H₂O | Liquid | Ceramic/ | Solid |
| organic/water | | | | | Polymer | |

The requirements for an anode material for battery application are:
Low operating voltage V⁻, this allows the full cell voltage V to be as high as possible (V═V⁺—V⁻, V⁺=the cathode operating voltage);
Low equivalent weight and volume, this relates to the energy density of the full in Wh/kg and Wh/l;
Fast kinetics, this relates to the power density (W/kg and W/I) in a large range of operating temperatures;
Chemical stability with electrolyte, this relates to the battery self-discharge rate;
Thermal stability, this relates to safety;
Environmentally benign and recyclability; and
Low cost (for $/Wh and $/W of the cell).

The lithiated carbon anode fulfills all these requirements except the high energy density as compared to metallic lithium and to some extent the safety one. The typical recharge time is in the order of one to five hours, which may not be practical in electric automobile applications. Lithium is known to form strongly reductive solutions such as butyl-lithium in hexane, lithium diphenylide and lithium naphthalenide in tetrahydrofuran (THF). For the later the dissolution reaction can be schematized as (reactants and products in THF):

Liₘₑₜₐₗ+C₈H₁₀ [symbol] Li(C₈H₁₀)ₛₒₗᵤₜᵢₒₙ (20)

In contact with an electrode, such as a porous carbon electrode, Li(C₈H₁₀) can act as an anode material to release the lithium cation (reactants and products in THF):

Li(C₈H₁₀) [symbol] Li⁺(solution)+e−(carbon)+C₈H₁₀ (solution) (21)

Adding metallic lithium will restore the active Li(C₈H₁₀) material in the solution according to Eq. 20, therefore acting as a “chemical” recharge of the anode. The so formed Li⁺ cation will migrate through the solid state electrolyte to the cathode side of the cell where a reduction takes place. Should water or oxygen be used as the cathode active material, the respective reactions are:

Li⁺+e⁻+H₂O [symbol] LiOH+1/2 H₂ (22)

Li⁺+e⁻+1/2 O₂ [symbol] 1/2 Li₂O (23)

Accordingly, the full cell reactions are:

Li(metal)+H₂O [symbol] LiOH+1/2 H₂ (24), and

2Li(metal)+1/2 O₂ [symbol] Li₂O (25).

The corresponding cell's open circuit voltages are e₅=2.59V and e₆=3.29V and theoretical energy density is 2.78 kWh/kg and 5.88 kWh/kg, respectively. In a practical battery the weight of other cell's components such as C₁₀H₈, THF, water, solid electrolyte and hardware are added, which can reduce the energy density by a factor of 2 to 4, depending on cell engineering. In a conservative assumption (reduction factor of 4) the two battery systems can still yield 695 Wh/kg and 1470 Wh/kg practical energy density, respectively.

Since dissolution of metallic lithium according to Eq.20 is well documented, there are two major issues to be addressed for a soluble lithium anode based battery to operate:

### I. Set Up a 2- and 3-Electrode Half Cells

Two- or three-electrode half cells can be designed to measure the open circuit voltage and the electrode kinetics. The corresponding electrochemical chain is:

(+) Carbon/Li(C₈H₁₀) in THF//ceramic separator//LiX in organic solvent/Li (−)

In the 3-electrode design an additional lithium reference electrode can be used in the right compartment of the cell. LiX is a soluble lithium salt such as LiPF₆ or LiBF₄ and organic solvent can be chosen among those used in lithium primary and rechargeable batteries such as propylene carbonate and ethylene carbonate. The main difficulty here is to insure the ceramic electrolyte makes a physical separation between the two liquid phase systems in the carbon anode compartment and the metallic lithium compartment. Solid state electrolytes such as those commercially available and highly stable lithium metal phosphates glasses and ceramics can fulfill such a task.

### II. Set Up a Full Cell

The full cell can be schematized as:

(−) Carbon/Li(C₈H₁₀) in THF//ceramic-separator//water/Carbon (+)

The full cell requires metallic lithium feed system on the anode side and a water (or air) feed system on the cathode side. Solutions can be found to match the reactive feeding rate with the discharge rate. For low and high temperature operations, other liquid cathode materials can be used, such as commercial SOCl₂ and SO₂ solutions in organic solvents.

Alternatively LiOH and Li₂O products can be recycled to produce metallic lithium by electrolysis, for example. Also the hydrogen produced in reaction (3) can be used as the fuel in a PEM fuel cell adding more power to the system.

### References

1. Handbook of Batteries, Third Edition, David Linden and Thomas B. Reddy, Eds., McGraw-Hill handbooks, 2002.

### Example 4

### Liquid Anode Based Battery with Anode and Cathode Regeneration Systems

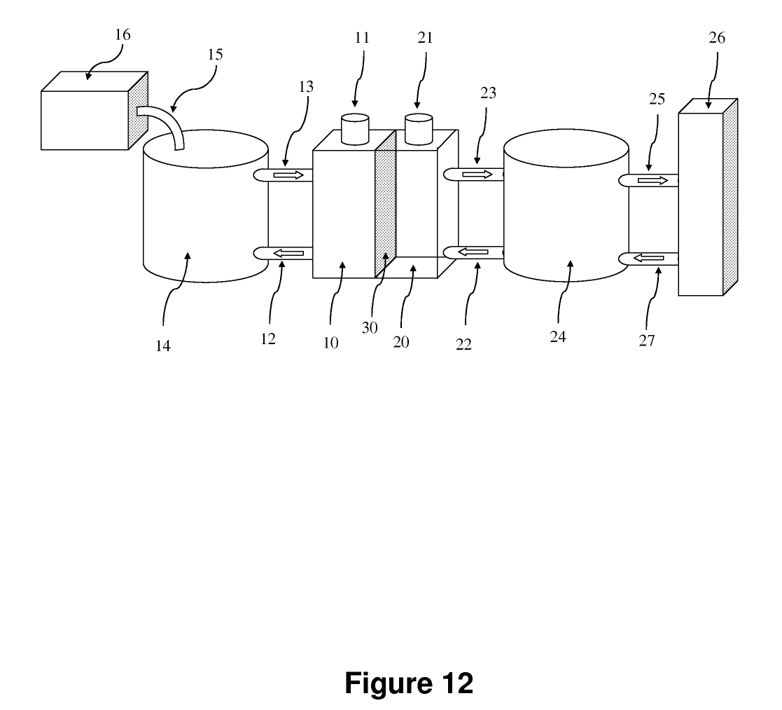

FIG. 12 provides a schematic of a flow cell design compatible with the methods and devices of the present invention. The flow cell comprises a liquid anode 10 and a cathode 20 connected by a separator membrane 30. The liquid anode 10 is connected by filling 13 and emptying 12 lines to a liquid anode reservoir 14. Spent liquid anode material is regenerated in the liquid anode reservoir 14 by a liquid anode regeneration tank 16 which is connect to the liquid anode reservoir 14 by a refill line 15. The cathode 20 is connected by filling 22 and emptying 23 lines to a cathode reservoir 24. Spent cathode material is regenerated in the cathode reservoir 24 by a cathode regeneration tank 26 which is connect to the cathode reservoir 24 by an emptying line 25 and a refill line 27. The flow cell may be discharged by connection to the negative pole 11 and positive pole 21. Alternatively, the flow cell can be electrically charged using a battery charger attached to the positive pole 21 and negative pole 11.

### Example 5

### Electrolytes for the Air Cathode and Dissolution of the Cathode Products

### General Background

Electrolytes for lithium electrochemical cells are limited to nonaqueous materials given the extremely reactive nature of lithium with water. Several classes of nonaqueous electrolytes have been successfully implemented for lithium electrochemical cells including: (i) solutions of lithium salts dissolved in organic or inorganic solvents, (ii) ionically conducting polymers, (iii) ionically conducting glass/ceramics and, (iv) fused lithium salts, including ionic liquids. Nonaqueous electrolyte solutions comprising lithium salts dissolved in polar organic solvents are currently the most widely adopted electrolytes for primary and secondary lithium cells. Useful solvents for these electrolytes include polar solvents that facilitate dissociation of lithium salts into their ionic components. Polar solvents exhibiting useful properties for lithium cell electrolytes include linear and cyclic esters (e.g., methyl formate, ethylene carbonate, dimethyl carbonate and propylene carbonate), linear and cyclic ethers (e.g., dimethoxyethane, and dioxolane), acetonitrile, and y-butyrolactone. Lithium salts in these electrolyte systems are typically salts comprising lithium and complex anions that have relatively low lattice energies so as to facilitate their dissociation in polar organic solvents. Lithium salts that have been successfully incorporated in electrolytes for these systems include LiClO₄, LiBF₄, LiAsF₆, LiSbF₆, LiAICl₄ and LiPF₆ provided at concentrations ranging from 0.01 M to 10M.

Successful implementation of polar organic solvent based electrolyte systems for air cathodes involves a number of considerations involving their chemical and physical properties. First, the electrolyte must exhibit a useful ionic conductivity. State of the art electrolytes for these systems, for example, exhibit ionic conductivities at 25 degrees Celsius greater than or equal to about 0.005 S cm⁻¹. Second, the electrolyte must be capable of wetting the active surfaces of the cathode, including the electrode pores structure. Third, the electrolyte must be chemically stable with respect to electrolytic degradation for relevant electrode material and discharge conditions. Forth, the electrolyte should be capable of dissolving the oxygen reduction products such as (Li/Na)₂Oₓ (x=1,2). Other physical properties of electrolytes useful for providing enhanced performance in alkali metal/air cells include thermal stability, low viscosity, low melting point, and high boiling point.

### Dissolution of Oxygen Reduction Products

Our strategy for dissolving the oxygen reduction products in the cathode compartment consists of introducing selected additives into the organic electrolyte known to form complexes with either the alkali metal (cation receptors) and the oxygen ions (anion receptors, acid-base couples):

The dissolution reaction of Li₂Oₓ (x=1, 2) via dissociation can be written as:

Li₂Oₓ→2Li⁺+xOⁿ⁻ (where n·x=2)

To increase Li₂Oₓ solubility many approaches can be undertaken:

### (i) Lewis Acid-Base Displacement

An acid (Ac) displacement would consist of coordination with the Oⁿ⁻ anion to release Li⁺, thus dissolving Li₂Oₓ:

Li₂Oₓ+pxAc→2Li⁺+xOAcₚ

For example, the dissociating agent can be one or more Lewis acids selected from the group consisting of BF₃, PF₅, SbF₅, AsF₅, AlCl₃, SnCl₄, FeCl₃, NbCl₅, TiCl₄, and ZnCl₂.

A base (Ba) displacement would consist of coordination with the Li⁺ cation release Oⁿ⁻, thus dissolving Li₂Oₓ:

Li₂Oₓ+2qBa→2LiBaq+xO²⁻

For example, the dissociating agent can be one or more Lewis bases selected from the group consisting of AlCl₄⁻, ClO₄⁻, SnCl₆²⁻, BF₄₋, PF₆⁻, and AsF₆⁻.

Precursor metal oxide dissolution compounds useful in the present solutions, formulations and methods include, but are not limited to, LiPF₆, LiBF₄, LiAsF₆, LiClO₄, LiSnCl₅, LiAlCl₄, LiFeCl₄, LiNbCl₆, LiTiCl₅, LiZnCl₃, NaPF₆, NaBF₄, NaAsF₆, NaClO₄, NaSnCl₅, NaAlCl₄, NaFeCl₄, NaNbCl₆, NaTiCl₅, NaZnCl₃, KPF₆, KBF₄, KAsF₆, KClO₄, KSnCl₅, KAlCl₄, KFeCl₄, KNbCl₆, KTiCl₅, KZnCl₃, NH₄PF₆, NH₄BF₄, NH₄AsF₆, NH₄ClO₄, NH₄SnCl₅, NH₄AlCl₄, NH₄FeCl₄, NH₄NbCl₆, NH₄TiCl₅, NH₄ZnCl₃, N(CH₃)₄ClO₄, N(CH₃)₄SnCl₅, N(CH₃)₄AlCl₄, N(CH₃)₄FeCl₄, N(CH₃)₄NbCl₆, N(CH₃)₄TiCl₅, N(CH₃)₄ZnCl₃, N(C₂H₇)₄ClO₄, N(C₂H₇)₄SnCl₅, N(C₂H₇)₄AlCl₄, and N(C₂H₇)₄FeCl₄, N(C₂H₇)₄NbCl₆, N(C₂H₇)₄TiCl₅, and N(C₂H₇)₄ZnCl₃.

### (ii) Anion Receptors

An anion receptor AR coordinate with the Oⁿ⁻ anion to release Li⁺, thus dissolving Li₂Oₓ, the reaction is not an acid-base reaction, rather it is a complex formation reaction:

Li₂Oₓ+pxAR→2Li⁺+xOARₚ (complex)

Anion receptors are a particularly useful class of dissociating agents in the present solutions, formulations and methods. As used herein, the term anion receptor refers to a molecule or ion which can bind or otherwise take up an anion in solution. Anion receptors useful in the present solutions, formulations and methods include, but are not limited to fluorinated and semifluorinated borate compounds, fluorinated and semifluorinated boronate compounds, fluorinated and semifluorinated boranes, phenyl boron compounds, aza-ether boron compounds, Lewis acids, cyclic polyammonium compounds, guanidinium compounds, calixarene compounds, aza-ether compounds, quaternary ammonium compounds, amines, imidazolinium based receptors, mercury metallacycle compounds, silicon containing cages, and macrocycles. Examples of calixarene compounds include cobaltocenium-based receptors, ferrocene-based receptors, π-metallated cationic hosts, calix[4]arenes, and calix[6]arenes. Examples of aza-ether anion receptors include linear aza-ethers, multi-branched aza-ethers, and cyclic aza-crown ethers. Examples of mercury metallacycle anion receptors include mercuracarborands and perfluoro-o-phenylenemercury metallacycles. Examples of anion receiving silicon-containing cages and macrocycles includes silsesquioxane cages and crown silanes.

Other examples of useful anion receptors can generally be found in the art. [See, e.g., Dietrich, Pure & Appl. Chem., Vol 65, No. 7, pp. 1457-1464, 1993; U.S. Pat. No. 5,705,689; U.S. Pat. No. 6,120,941; Matthews and Beer, Calixarene Anion Receptors, in Calixarenes 2001, pp. 421-439, Kluwer Academic Publishers, The Netherlands; Rodionov, State of the Art in Anion Receptor Design, American Chemical Society Division of Organic Chemistry Fellowship Awardee Essay 2005-2006; H. S. Lee, X. Q. Yang, C. L. Xiang, J. McBreen, L. S. Choi, “The Synthesis of a New Family of Boron-Based Anion Receptors and the Study of Their Effect on Ion Pair Dissociation and Conductivily of Lithium Salts in Nonaqueous Solutions”, J. Electrochem. Soc., Vol. 145, No. 8, August 1998; H. S. Lee, Z. F. Ma, X. Q. Yang, X. Sun and J. McBreen, “Synthesis of a Series of Fluorinated Boronate Compounds and Their Use as Additives in Lithium Battery Electrolytes”, Journal of The Electrochemical Society, 151 (9) A1429-A1435 (2004); and X. Sun, H. S. Lee, S. Lee, X. Q. Yang and J. Mc Breen, “A Novel Lithium Battery Electrolyte Based on Lithium Fluoride and a Tris(pentafluorophenyl) Borane Anion Receptor in DME” Electrochemical and Solid-State Letters, 1 (6) 239-240 (1998).]

(iii) Cation Receptors

A cation receptor (CR) coordinates with the Li⁺ anion to release Oⁿ⁻, thus dissolving Li₂Oₓ, the reaction is not an acid-base reaction, rather a complex formation reaction:

Li₂Oₓ+2qCR→2Li⁺+xOCRₚ (complex)

Crown ethers are a class of cation receptors exhibiting chemical and physical properties beneficial for enhancing the dissolution of inorganic fluorides, including LiF. These compounds are useful for complexing with metal ions in solution. Crown ether cation receptors useful in the present invention include, but are not limited to, Benzo-15-crown-5, 15-Crown-5, 18-Crown-6, Cyclohexyl-15-crown-5, Dibenzo-18-crown-6, Dicyclohexyl-18-crown-6, Di-t-butyldibenzo-18-crown-6, 4,4i⁻(5i⁻)-Di-tert-butyldibenzo-24-crown-8, 4-Aminobenzo-15-Crown-5, Benzo-15-Crown-5, Benzo-18-crown-6, 4-tert-Butylbenzo-15-crown-5, 4-tert-Butylcyclohexano-15-crown-5, 18-Crown-6, Cyclohexano-15-crown-5, Di-2,3-naphtho-30-crown-10, 4,4′(5′)-Di-tertbutyldibenzol 8-crown-6, 4′-(5′-Di-tert-butyldicyclohexano-18-crown-6, 4,4′(5′)-Di-tertbutyldicyclohexano-24-crown-8, 4,10-Diaza-15-crown-5, Dibenzo-18-crown-6, Dibenzo-21-crown-7, Dibenzo-24-crown-8, Dibenzo-30-crown-10, Dicyclohexano-18-crown-6, Dicyclohexano-21-crown-7,Dicyclohexano-24-crown-8, 2,6-Diketo-18-crown-6, 2,3-Naphtho-15-crown-5, 4′-Nitrobenzo-15-crown-5, Tetraaza-12-crown-4 tetrahydrochloride, Tetraaza-12-crown-4 tetrahydrogen sulfate, 1,4,10,13-Tetraoxa-7,16-diazacyclooctadecane, 12-crown-4, 15-crown-5, and 21-crown-7.

### (iv) Ionic Liquids

Ionic liquids useful for metal oxide dissolution include, but are not limited to, the following:

Acetates: 1-Butyl-3-methylimidazolium trifluoroacetate, 1-Butyl-1-methylpyrrolidinium trifluoroacetate, 1-Ethyl-3-methylimidazolium trifluoroacetate, and Methyltrioctylammonium trifluoroacetate.

Amides and Imides: 1-Butyl-2,3-dimethylimidazolium bis(trifluoromethylsulfonyl)imide, 1-Butyl-3-methylimidazolium bis(trifluoromethylsulfonyl)imide, 490015 1-Butyl-3-methylimidazolium dicyanamide, 1-Butyl-1-methylpyrrolidinium bis(trifluoromethylsulfonyl)imide, 1-Butyl-1-methylpyrrolidinium bis(trifluoromethylsulfonyl)imide, 1-Butyl-1-methylpyrrolidinium bis(trifluoromethylsulfonyl)imide, 1-Butyl-1-methylpyrrolidinium dicyanamide, 2,3-Dimethyl-1-propylimidazolium bis(trifluoromethylsulfonyl)imide, 1-(2-Ethoxyethyl)-1-methylpyrrolidinium bis(trifluoromethylsulfonyl)imide, and N-Ethoxymethyl-N-methylmorpholinium bis(trifluoromethylsulfonyl)imide.

Borates: 1-Butyl-2,3-dimethylimidazolium tetrafluoroborate, 1-Butyl-3-methylimidazolium tetrafluoroborate, 1-Butyl-3-methylimidazolium tetrafluoroborate, N-Butyl-3-methylpyridinium tetrafluoroborate, N-Butyl-4-methylpyridinium tetrafluoroborate, 1-Butyl-1-methylpyrrolidinium bis[oxalato(2-)]borate, 490051 N-Butylpyridinium tetrafluoroborate, 1-Ethyl-3-methylimidazolium bis[oxalato(2-)-O,O⁺]borate, 1-Ethyl-3-methylimidazolium tetrafluoroborate, and 1-Hexyl-3-methylimidazolium tetrafluoroborate.

Cyanates: 1-Butyl-3-methylimidazolium dicyanamide, N-Butyl-3-methylpyridinium dicyanamide, 1-Butyl-1-methylpyrrolidinium dicyanamide, and 1-Ethyl-3-methylimidazolium thiocyanate.

Halogenides: 1-Benzyl-3-methylimidazolium chloride, 1-Butyl-1-methylpyrrolidinium bromide, N-Butyl-3-methylpyridinium bromide, 1-Butyl-2,3-dimethylimidazolium chloride, 1-Butyl-2,3-dimethylimidazolium iodide, 490087 1-Butyl-3-methylimidazolium bromide, 1-Butyl-3-methylimidazolium chloride, 1-Butyl-3-methylimidazolium iodide, N-Butyl-3-methylpyridinium chloride, and N-Butyl-4-methylpyridinium chloride.

Other: 1-Butyl-3-methylimidazolium tricyanomethane, N-Butyl-3-methylpyridinium dicyanamide, 1-Butyl-1-methylpyrrolidinium dicyanamide, and1-Ethyl-3-methylimidazolium hydrogensulfate.

Phosphates and Phosphinates: N-Butyl-3-methylpyridinium hexafluorophosphate, 1-Butyl-2,3-dimethylimidazolium hexafluorophosphate, 1-Butyl-3-methylimidazolium hexafluorophosphate, 1-Butyl-3-methylimidazolium hexafluorophosphate, 1-Butyl-3-methylimidazolium hexafluorophosphate, 1-Butyl-1-methylpyrrolidinium tris(pentafluoroethyl)trifluorophosphate, 1-Butyl-1-methylpyrrolidinium tris(pentafluoroethyl)trifluorophosphate, 1,3-Dimethylimidazolium dimethylphosphate, 1-Ethyl-3-methylimidazolium diethylphosphate, and Guanidinium tris(pentafluoroethyl)trifluorophosphate.

Sulfates and Sulfonates: 1-Butyl-3-methylimidazolium methanesulfonate, N-Butyl-3-methylpyridinium trifluoromethanesulfonate, 1-Butyl-2,3-dimethylimidazolium trifluoromethanesulfonate, 1-Butyl-3-methylimidazolium hydrogensulfate, 1-Butyl-3-methylimidazolium methylsulfate, 1-Butyl-3-methylimidazolium octylsulfate, 1-Butyl-3-methylimidazolium trifluoromethanesulfonate, 1-Butyl-3-methylimidazolium trifluoromethanesulfonate, 1-Butyl-3-methylimidazolium trifluoromethylsulfonate, and N-Butyl-3-methylpyridinium methylsulfate.

Ammoniums: N-Ethyl-N,N-dimethyl-2-methoxyethylammonium bis(trifluoromethylsulfonyl)imide, Ethyl-dimethyl-propylammonium bis(trifluoromethylsulfonyl)imide, Ethyl-dimethyl-propylammonium bis(trifluoromethylsulfonyl)imide, (2-Hydroxyethyl)trimethylammonium dimethylphosphate, Methyltrioctylammonium bis(trifluoromethylsulfonyl)imide, Methyltrioctylammonium trifluoroacetate, Methyltrioctylammonium trifluoromethanesulfonate, Tetrabutylammonium bis(trifluoromethylsulfonyl)imide, Tetramethylammonium bis(oxalato(2-))-borate, and Tetramethylammonium tris(pentafluoroethyl)trifluorophosphate.

Guanidiniums: Guanidinium trifluoromethanesulfonate, Guanidinium tris(pentafluoroethyl)trifluorophosphate, and Hexamethylguanidinium tris(pentafluoroethyl)trifluorophosphate.

Imidazoles: 1-Benzyl-3-methylimidazolium chloride, 1-Butyl-3-methylimidazolium methanesulfonate, 1-Butyl-2,3-dimethylimidazolium bis(trifluoromethylsulfonyl)imide, 1-Butyl-3-methylimidazolium bis(trifluoromethylsulfonyl)imide, 1-Butyl-3-methylimidazolium bromide, 1-Butyl-3-methylimidazolium chloride, 1-Butyl-3-methylimidazolium dicyanamide, 1-Butyl-3-methylimidazolium hexafluorophosphate, 1-Butyl-3-methylimidazolium hexafluorophosphate, 1-Butyl-3-methylimidazolium hexafluorophosphate, 1-Butyl-2,3-dimethylimidazolium chloride, 1-Butyl-2,3-dimethylimidazolium hexafluorophosphate, 1-Butyl-2,3-dimethylimidazolium iodide, 1-Butyl-2,3-dimethylimidazolium tetrafluoroborate, 1-Butyl-2,3-dimethylimidazolium trifluoromethanesulfonate, 2,3-Dimethyl-1-propylimidazolium bis(trifluoromethylsulfonyl)imide, 1-Ethyl-2,3-dimethylimidazolium chloride, 1-Hexyl-2,3-dimethylimidazolium chloride, 1-Hexyl-2,3-dimethylimidazolium tris(pentafluoroethyl)trifluorophosphate, and 1-(2-Hydroxyethyl)-3-methylimidazolium bis(trifluoromethylsulfonyl)imide.

Phosphoniums: Trihexyl(tetradecyl)phosphonium bis[oxalato(2-)]borate, Trihexyl(tetradecyl)phosphonium bis(trifluoromethylsulfonyl)imide, Trihexyl(tetradecyl)phosphonium tris(pentafluoroethyl)trifluorophosphate, and Trihexyl(tetradecyl)phosphonium tris(pentafluoroethyl)trifluorophosphate.

Pyridines: N-Butyl-3-methylpyridinium bromide, N-Butyl-3-methylpyridinium hexafluorophosphate, N-Butyl-3-methylpyridinium trifluoromethanesulfonate, N-Butyl-3-methylpyridinium chloride, N-Butyl-4-methylpyridinium chloride, N-Butyl-3-methylpyridinium dicyanamide, N-Butyl-3-methylpyridinium methylsulfate, N-Butyl-3-methylpyridinium tetrafluoroborate, N-Butyl-4-methylpyridinium tetrafluoroborate, and N-Butylpyridinium chloride.

Pyrrolidines: 1-Butyl-1-methylpyrrolidinium bromide, 1-Butyl-1-methylpyrrolidinium bis[oxalato(2-)]borate, 1-Butyl-1-methylpyrrolidinium bis(trifluoromethylsulfonyl)imide, 1-Butyl-1-methylpyrrolidinium bis(trifluoromethylsulfonyl)imide, 1-Butyl-1-methylpyrrolidinium bis(trifluoromethylsulfonyl)imide, 1-Butyl-1-methylpyrrolidinium chloride, 1-Butyl-1-methylpyrrolidinium dicyanamide, 1-Butyl-1-methylpyrrolidinium dicyanamide, 1-Butyl-1-methylpyrrolidinium trifluoroacetate, and 1-Butyl-1-methylpyrrolidinium trifluoromethanesulfonate.

Electrolytes for lithium electrochemical cells are limited to nonaqueous materials given the extremely reactive nature of lithium with water. Several classes of nonaqueous electrolytes have been successfully implemented for lithium electrochemical cells including: (i) solutions of lithium salts dissolved in organic or inorganic solvents, (ii) ionically conducting polymers, (iii) ionic liquids and (iv) fused lithium salts. Nonaqueous electrolyte solutions comprising lithium salts dissolved in polar organic solvents are currently the most widely adopted electrolytes for primary and secondary lithium cells. Useful solvents for these electrolytes include polar solvents that facilitate dissociation of lithium salts into their ionic components. Polar solvents exhibiting useful properties for lithium cell electrolytes include linear and cyclic esters (e.g., methyl formate, ethylene carbonate, dimethyl carbonate and propylene carbonate), linear and cyclic ethers (e.g., dimethoxiethane, and dioxolane) acetonitrile, and rbutyrolactone. Lithium salts in these electrolyte systems are typically salts comprising lithium and complex anions that have relatively low lattice energies so as to facilitate their dissociation in polar organic solvents. Lithium salts that have been successfully incorporated in electrolytes for these systems include LiClO₄, LiBF₄, LiAsF₆, LiSbF₆, LiAlCl₄ and LiPF₆ provided at concentrations ranging from 0.01 M to 1 M.

Crown ethers are a class of cation receptor exhibiting chemical and physical properties beneficial for enhancing the dissolution of (Li/Na)₂Oₓ. These compounds are useful for complex formation with metal ions in solution. Useful crown ether cation receptors include 12-Crown-4, 15-Crown-5, 18-Crown-6 and other Benzo-crown ether and Cyclohexyl-crown ether derivatives.

Anion receptors are a class of compounds that have been recently developed as additives to increase the ionic conductivity of nonaqueous electrolyte solutions (See, e.g., U.S. Pat. Nos. 6,022,643, 6,120,941, and 6,352,798). Anion receptors enhance the ionic disassociation of lithium salts in low dielectric solvents by incorporating non-hydrogen bonded electrophilic groups that participate in complex formation reactions with anions of the lithium salt provided to the electrolyte. Some anion receptor additives have been demonstrated to enhance the dissolution of specific lithium salts in a manner resulting in an increase in solubility by several orders of magnitude. Anion receptor additives encompass a wide range of compounds including fluorinated boron-based anion receptors, such as boranes, boronates and borates having electron withdrawing ligands, polyammonium compounds, guanidiniums, calixarene compounds, and aza-ether compounds. Successful integration of anion receptors in lithium batteries, however, depends on a number of key factors. First, the anion receptor must be stable with respect to electrolyte decomposition under useful discharge and charging conditions. Second, anion receptors should be capable of releasing (or de-complexing) complexed anions so as not to hinder intercalation reactions at the electrodes. Third, the anion receptor itself preferably should not participate in intercalation with intercalation host material, and if it does participate in such intercalation reactions it should not result in mechanically induced degradation of the electrodes.

Lewis acids and bases are also able to interact with either the alkali-metal cation or the oxide and the peroxide anions through acid-base type reactions. We have found that Li₂O₂ and Li₂O dissolve readily at ambient or at moderately hot temperatures into conventional lithium and lithium-ion battery organic electrolytes containing LiPF₆, LiClO₄ and LiBF₄ salts. The formation of more complex anions and cations combining Li, X (X=anion PF₆, ClO₄ and BF₄) and O can lead to greater Li₂O₂ and Li₂O dissolution.

### Oxygen Dissolution

Another important desired attribute of the cathode electrolyte (catholyte) is a high oxygen dissolution rate, such as a high Bunsen coefficient α(reported in units of cm³ O₂/cm³ liquid) and a high oxygen chemical diffusion coefficient. Table 5.1 displays the oxygen Bunsen coefficient of single (a) and mixed (b) solvents. High α coefficients are achieved in single solvents such as alkyl carbonates (DMC, DPC, DEC, EMC) and in ethers (THF and DME). As Table 5.1 shows, mixing the former solvents with PC, which has a low α coefficient, enhances the oxygen dissolution by a factor of two or so. Therefore, an appropriate solvent combination (i. e. carbonates+ethers) can result in a significant enhancement of the oxygen Bunsen coefficient.

TABLE 5.1
Bunsen dissolution coefficient α measured at
25° C. for single and mixed solvents

| Solvent | α | Solvent mix | α |
|---|---|---|---|
| Tetramethylene sulfone | 0.0357 | PC:TMSO | 0.0429 |
| (TMSO)^{a} | | (1:4 w/w) | |
| Ethylene carbonate (EC)^{a} | 0.0382 | PC:EC (1:3 w/w) | 0.0449 |
| Dimethyl sulfoxide (DMSO) | 0.0416 | PC:EC (1:1 w/w) | 0.0584 |
| γ-Butyrolactone (γ-BL) | 0.0550 | PC:DME (3:1 w/w) | 0.0862 |
| Propylene carbonate (PC) | 0.0718 | PC:DMC (1:1 w/w) | 0.0999 |
| N-methyl pyrrolidinone (NMP) | 0.0721 | PC:DEC (1:1 w/w) | 0.1168 |
| Tetrathylene glycol dimethyl | 0.0993 | PC:DME (1:1 w/w) | 0.1185 |
| ether | | γ-BL:DME | 0.1253 |
| Triethylene glycol dimethyl | 0.1054 | (1:2 w/w) | |
| ether | | PC:DME (1:2 w/w) | 0.1335 |
| Dimethyl carbonate (DMC) | 0.1632 | PC:DME (1:4 w/w) | 0.1532 |
| Dipropyl carbonate (DPC) | 0.1754 | | |
| Diethyl carbonate (DEC) | 0.1773 | | |
| Ethyl methyl carbonate (EMC) | 0.1780 | | |
| Tetrahydrofuran (THF) | 0.1978 | | |
| 1,2-dimethoxyethane (DME) | 0.2143 | | |

Reproduced from Solubility Data Series, Vol. 7, Oxygen and Ozone, R. Battino, Editor, p. 187, Permagon, New York, 1981.

Preferred solvent combinations for the cathode electrolytes, therefore, include solvent combinations that provide (i) high dissolution of the lithium and sodium supporting electrolyte such as Li(Na)PF₆, Li(Na)BF₄ and Li(Na)C₄BO₈ (bis(oxalate)borate), and (ii) a high oxygen chemical diffusion coefficient. The Bunsen coefficient can be increased by the use of polyfluorocarbons (PCFs) of general formulae CₙF₂ₙ₊₂. PCFs are known to dissolve large amounts of oxygen, which provides a basis for biomedical applications, in particular as oxygen carriers mimicking human blood. The most important common characteristic of PFCs is their outstanding chemical and biological inertness. One reason for this inertness arises from the strength of the C—F and skeletal C—C bonds and from the repulsive dense electron coating that protects perfluoroalkyl chains. Use of PCF dispersions or solutions in the catholyte, therefore, can result in enhanced oxygen dissolution and transport properties.

Fluosol (20% intravascular perfluorochemical emulsion) is an oxygen-carrying emulsion used to deliver oxygen to ischemic myocardium during percutaneous transluminal coronary angioplasty (PTCA). Fluosol is composed of two perfluorochemicals, perfluorodecalin and perfluorotripropylamine. It has a high capacity for oxygen solubility, a low viscosity, and a small particle size. Fluosol is an artificial blood substitute which is milky in color. Its main ingredients are perfluorodecalin or perfluorotributylamine in Fluosol-DA and Fluosol-43 respectively, perfluorochemicals suspended in an albumin emulsion. It was developed in Japan and first tested in the United States in 1982, its recipients being individuals who refused blood transfusions on religious grounds. Fluosol serves as a dissolving medium for oxygen and has low viscosity.

Other blood substitute oxygen dissolution species are described in: Best. Pract. Res. Clin. Anaesthesiol, 22 (1): 63-80, 2008; Journal Of Fluorine Chemistry, 129 (11): 1096-1103, 2008; Artificial Cells Blood Substitutes And Biotechnology, 35 (1): 119-124, 2007; Expert Opinion On Drug Delivery, 4 (3): 247-262, 2007; Macromolecular Bioscience, 7 (6): 836-845, 2007; Journal Of Biomedical Materials Research Part B—Applied Biomaterials, 81b (1): 261-268, 2007; Biorheology, 44179-190, 2007; Journal Of The American College Of Cardiology, 501272-1278, 2007; Transfusion And Apheresis Science, 37 (3): 251-259, 2007; Pediatrics International, 48 (6): 608-615, 2006; Journal Of Materials Chemistry, 16 (43): 4189-4196, 2006; Archivos De Cardiologia De Mexico, 76 (Suppl. 2): S100-S106, 2006; And Photochemical & Photobiological Sciences, 5 (8): 770-777, 2006; which are each hereby incorporated by reference in their entireties to the extent not inconsistent with the present description.

### The Air Cathode Design

The cathodes described herein are designed to dissolve products of the oxygen reduction reaction at the cathode, such as Li₂O₂ and Li₂O. The later precipitates on the electrode surfaces and clogs their pores, hence reducing the discharge rates and cycleability of the electrochemical generators described herein.

The cathode reaction converts gaseous oxygen to lithium oxide and peroxide. The chemical nature of the electrolyte favors the formation of either form, Li₂O₂ (mostly in organic and polymer electrolytes) and Li₂O in aqueous media. The conversion of oxygen to peroxide and oxide requires a multi-step multi electron transfer that schematically can be described as: O₂+2e⁻→O₂²⁻+2e⁻→2O²⁻

The kinetics of the oxygen reduction is controlled by several factors such as the oxygen concentration in the electrolyte, the oxygen diffusion coefficient and by the rate of the charge transfer reaction. The cathode design and engineering is crucial in the overall cathode kinetics in order to reduce the cathode polarization due to mass transport and charge transfer. What is typically required, in addition to high oxygen concentration discussed in herein, is an easy access of dissolved oxygen to the electrode surfaces and a fast charge transfer mechanism. Moreover, the reduction products Li₂O₂ and Li₂O should be removed from the cathode to keep a high active surface area. Accordingly preferred cathode designs offer a microporous medium for the oxygen transport to the Helmholtz double-layer surface and use specific catalysts for oxygen reduction.

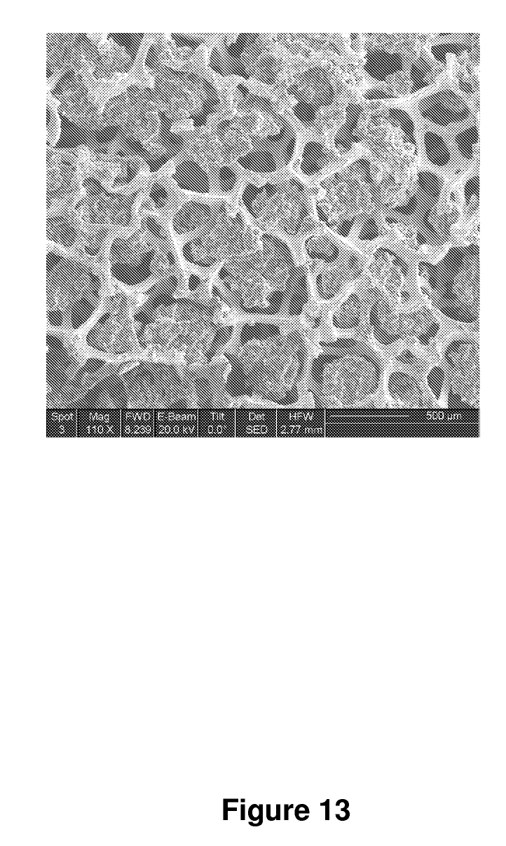

FIG. 13 provides an SEM image of an air cathode. Carbon composite is impregnated in/on the Ni foam. [Adapted from S. D. Beattie, D. M. Manolescu, S. L. Blair, J. Electrochem. Soc., 156 1 A44-A47, 2009.] FIG. 13 shows an example of cathode with porous structure (nickel foam framework) with imbedded Ketjen black and polyvinylidene fluoride (PVdF) composite. Such a structure allows for a uniform electron distribution owing to the nickel foam and offers a high active surface area owing to the Ketjen black. The PVdF acts as a binder and also electrolyte “sponge” allowing for easy oxygen transport to the active surface. Such a cathode design can be improved by the use of catalysts known to activate oxygen reduction, including transition metal oxides MOₓ, M═Mn, V, Ni, Ru, Ti and ferrocenes.

### Example 6

### Cathode Experimental Results

### Oxygen Dissolution

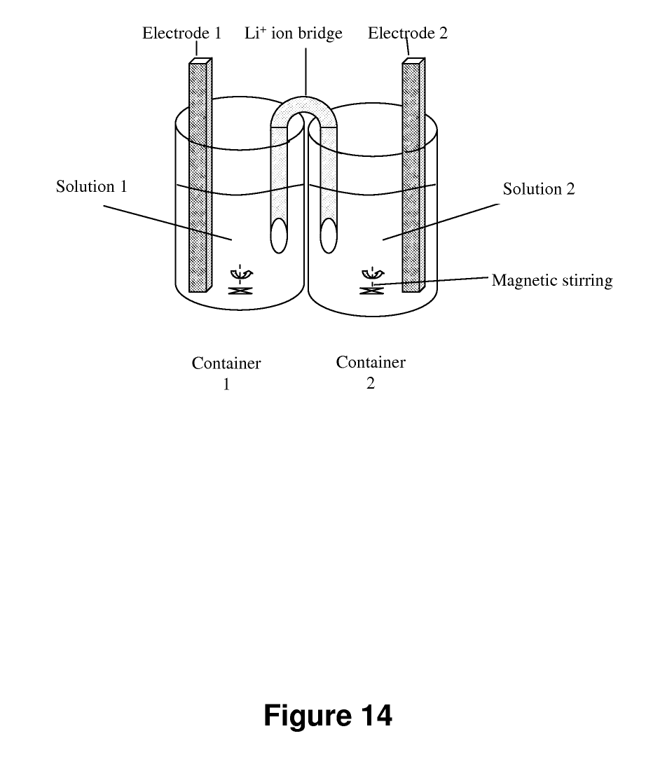

The effect of additives to the liquid solution and emulsion on the oxygen dissolution, hence on the electrode voltages was measured in a test electrochemical cell shown in FIG. 14. The test cell consisted of the following: Two glass containers filled with solution 1 and solution 2. The solutions were magnetically stirred in air for oxygen saturation. An electrode dipped in each container (here a porous nickel felt is used). An ion bridge between the two containers. The ion bridge contains solution 1.

The cell voltage ΔV=V(electrode 2)−V(electrode 1) was measured at ambient temperature. Different liquid solutions/emulsions were prepared. A first set of solutions (solution 1) consisted of lithium carbonate dissolved in di-ionized water and of lithium bis(oxalate)borate (LiBOB) dissolved in acetone. A second set of solutions/emulsions (solution 2) consisted of solution 1 to which an additive was added. Additives use were fluorinated polymers such as polytetrafluoroethylene (PTFE) in a water (emulsion) and polyvinylidene fluoride (PVDF). Two types of PVDF were used: a water soluble PVDF (PVDF-SOL) and a water insoluble PVDF (PVDF-INSOL). Both PVDFs are soluble in acetone. Table 6.1 shows the results of the cell voltage measurements in each case.

TABLE 6.1
Cell voltage range as function of solution
1 and solution 2 compositions.

| | | Solution1 | | |
|---|---|---|---|---|
| | | Li₂CO₃ in | | LiBOB in |
| | | water | | acetone |
| Cell # | Solution 2 | ΔV (mV) | | ΔV (mV) |
| 1 | Li₂CO₃ in water | +/−2 | | — |
| 2 | Li₂CO₃ in water + PVDF- | 50-100 | mV | — |
| | SOL | | | |
| 3 | Li₂CO₃ in water + PVDF- | (−20)-(−50) | mV | — |
| | INSOL | | | |
| 4 | Li₂CO₃ in water + PTFE | 50-110 | mV | — |

| | | | |
|---|---|---|---|
| 5 | LiBOB in acetone | — | +/−2 |
| 6 | LiBOB in acetone + PVDF | — | 30-80 mV |
| 7 | LiBOB in acetone + PTFE | — | 50-120 mV |

The results clearly show that where the fluoro-polymer additive dissolves or makes an emulsion in solution 2, the electrode potential in solution 2 is more positive than that in the associated solution 1, without the fluoro-polymer. On the contrary, when the fluoro-polymer is not dissolved or doesn't form an emulsion the potential is more negative (cell #3).

The cell voltage is fixed by the oxygen activity at both electrodes. The electrode reaction can be schematically written as: 2Li⁺+2e⁻+x/2 O₂ [symbol] Li₂Oₓ (x=1, 2)

In a first degree approximation the cell voltage is given by the Nernst equation:

$$Δ V = \frac{RT}{n F} ln \frac{{P}_{{o}_{2}} ( 2 )}{{P}_{{o}_{2}} ( 1 )}$$

where n=2 or 4 depending on the reaction product (n=4 for Li₂O₂ and n=2 for Li₂O) and Pₒ_{₂}(1) and Pₒ_{₂}(2) is the oxygen local pressure at electrode 1 and 2, respectively. A positive ΔV indicates a higher oxygen local pressure on electrode 2 and a negative ΔV indicated a lower oxygen local pressure. Therefore fluorinated polymers that form a solution and an emulsion increase the oxygen activity (local pressure) on the electrode due to interaction with oxygen therefore enhancing the oxygen dissolution.

Other fluorinated polymers are known to enhance oxygen dissolution, including perflurocarbons (PFCs) and PFC derivatives (Fluoso!). Due to higher oxygen dissolution and transport properties, PFCs and PFCs derivatives (Fluosol) are used for artificial blood applications.

Dissolution of M₂Oₓ (M═Li, Na, x=1, 2) in Different Solvent Media

Objective: Dissolve metal oxides, peroxides and hydroxides in different solvent or electrolyte solutions used as catholyte for metal/air batteries.

Materials: Li₂O, Li₂O₂, Na₂O₂ , LiOH and NaOH.

Procedure: Materials were added to the pure or to mixed solvents or to the electrolyte solution and magnetically stirred for several hours at ambient temperatures and at 50 C, when dissolution was not achieved at the ambient. Results are presented in Table 6.2 and Table 6.3.

TABLE 6.2
Lithium Oxide and Lithium Hydroxide Dissolution in Selected Solvents

| | Solvent | | | | | | |
|---|---|---|---|---|---|---|---|
| | LiPF₆/ | | | | | | |
| | EC- | | LiCl0₄/ | | EC- | PC/12- | BMI- |
| Solute | DMC | LiBF₄/GBL | PC | PC | DMC | crown-4 | PF₆ |
| Li₂O | Y | Y, 50° C. | Y, 50° C. | VL | VL | L | L |
| Li₂O₂ | Y | Y | Y | VL | VL | L | L |
| LiOH | Y | VL | VL | VL | VL | — | VL |

TABLE 6.3
Sodium Oxide and Sodium Hydroxide Dissolution in Selected Solvents

| | Solvent | | | | | | | |
|---|---|---|---|---|---|---|---|---|
| | LiPF₆/ | LiBF₄/ | LiCl0₄/ | | | 15- | NaPF₆/ | |
| Solute | EC-DMC | GBL | PC | PC | EC-DMC | crown-5 | CH₃CN | BMI-PF₆ |
| Na₂O₂ | VL | VL | VL | VL | VL | L | Y | Y |
| NaOH | — | — | — | VL | VL | — | Y | Y |

### Table 6.2 and Table 6.3 Abbreviations:

Y: Yes dissolved EC=Ethylene carbonate, DMC=dimethyl carbonate, GBL=gamma
L: Low dissolution butyrolactone,
VL=Very low PC=propylene carbonate,
dissolution BMI-PF₆=1-butyl 3 methylimidazolium hexafluorophosphate

### Statement Regarding Incorporation by Reference and Variations

Each reference cited herein is hereby incorporated by reference in its entirety. However, if any inconsistency arises between a cited reference and the present disclosure, the present disclosure takes precedent. Some references provided herein are incorporated by reference to provide details concerning the state of the art prior to the filing of this application, other references can be cited to provide additional or alternative device elements, additional or alternative materials, additional or alternative methods of analysis or applications of the invention. Patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, methods steps set forth in the present description. As will be obvious to one of skill in the art, methods and devices useful for the present methods can include a large number of optional composition and processing elements and steps.

One of ordinary skill in the art will appreciate that device elements, as well as materials, shapes and dimensions of device elements, as well as methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed can be resorted to by those skilled in the art, and that such modifications and variations are considered to be within the scope of this invention.

When a Markush group or other grouping is used herein, all individual members of the group and all combinations and possible subcombinations of the group are intended to be individually included in the disclosure. Every combination of components or materials described or exemplified herein can be used to practice the invention, unless otherwise stated. One of ordinary skill in the art will appreciate that methods, device elements, and materials other than those specifically exemplified can be employed in the practice of the invention without resort to undue experimentation. All art-known functional equivalents, of any such methods, device elements, and materials are intended to be included in this invention. Whenever a range is given in the specification, for example, a temperature range, a frequency range, a time range, or a composition range, all intermediate ranges and all subranges, as well as, all individual values included in the ranges given are intended to be included in the disclosure. Any one or more individual members of a range or group disclosed herein can be excluded from a claim of this invention. The invention illustratively described herein suitably can be practiced in the absence of any element or elements, limitation or limitations which is not specifically disclosed herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. The term “comprising” is intended to be broader than the terms “consisting essentially of” and “consisting of”, however, the term “comprising” as used herein in its broadest sense is intended to encompass the narrower terms “consisting essentially of” and “consisting of.”, thus the term “comprising” can be replaced with “consisting essentially of” to exclude steps that do not materially affect the basic and novel characteristics of the claims and “comprising” can be replaced with “consisting of” to exclude not recited claim elements.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed can be resorted to by those skilled in the art, and that such modifications and variations are considered to be within the scope of this invention as defined by the appended claims.

Although the description herein contains many specifics, these should not be construed as limiting the scope of the invention, but as merely providing illustrations of some of the embodiments of the invention.

What is claimed is:

1. An electrode for use in an electrochemical generator, the electrode comprising:
a solvent having metal ions and oxygen dissolved therein, wherein the metal ions are alkali metal ions, alkali earth metal ions, or lanthanide metal ions;
a fluorinated or metalloprotein oxygen dissolution enhancer provided in the solvent for enhancing dissolution of the oxygen in the solvent;
a metal oxide dissolution enhancer provided in the solvent, the metal oxide dissolution enhancer for enhancing dissolution of metal oxide formed via reaction of the oxygen with the metal ions in the solvent; and
a current collector provided in electrical contact with the solvent.

2. The electrode of claim 1, further comprising an oxygen reduction catalyst provided in physical contact with the solvent and the current collector.

3. The electrode of claim 2, wherein the oxygen reduction catalyst is provided as an outer layer of the current collector exposed to the solvent.

4. The electrode of claim 2, wherein the oxygen reduction catalyst comprises a transition metal, a transition metal alloy, a transition metal oxide, a transition metal nitride, a transition metal carbide, a transition metal silicide, a noble metal, an organo-metallic compound, a cobalt porphyrine, a conjugated polymer, polypyrrole, polyaniline, polyacetylene, polyparaphenylene, polythiophene, cobalt phthalocyanine, (5,10,15,20-tetramethylporphyrinato) cobalt(II), ferrocene, or a combination thereof.

5. The electrode of claim 1, wherein the solvent is water, an organic solvent an alkyl carbonate, an ether, an ester, or a combination thereof.

6. The electrode of claim 1, wherein the metal oxide has the formula M_{y}Oₓ, wherein M is an electron donor metal, y is 1, 2 or 3 and x is 1, 2, 3 or 4.

7. The electrode of claim 6, wherein the electron donor metal is lithium, sodium, potassium, rubidium, magnesium, calcium, aluminum, zinc, carbon, silicon, germanium, lanthanum, europium, cerium, strontium, barium or alloy thereof.

8. The electrode of claim 6, wherein the electron donor metal is a metal other than lithium.

9. The electrode of claim 1, wherein the fluorinated or metalloprotein oxygen dissolution enhancer is a fluorinated polymer; polytetrafluoroethylene; perfluoroalkoxy polymer; fluorinated ethylene propylene; ethylene tetrafluoroethylene; ethylene chlorotrifluoroethylene; polyvinylidene fluoride; polychlorotrifluoroethylene; a polymethylene-type perfluoro rubber having all substituents on the polymer chain either fluoro, perfluoroalkyl or perfluoroalkoxy groups; a polymethylene-type fluororubber having fluoro and perfluoroalkoxy substituent groups in the main chain; polyvinylfluoride; perfluoropolyether; Nafion; or combination thereof.

10. The electrode of claim 1, wherein the fluorinated or metalloprotein oxygen dissolution enhancer is a fluorinated ether, a fluorinated ester, a fluorinated carbonate, a fluorinated carbon material, a fluorinated blood substitute, a metalloprotein, or a mixture thereof.

11. The electrode of claim 10, wherein the fluorinated or metalloprotein oxygen dissolution enhancer is a fluorinated ether having the general formula Cₘ₊ₙH₂ₘ₊₁F₂ₙ₊₁O; wherein n is an integer from 1 to 10 and m is an integer from 1 to 10.

12. The electrode of claim 11, wherein the fluorinated ether is: 1-(difluoromethoxy)-1,1,2-trifluoroethane; 1-(difluoromethoxy)-1,2,2-trifluoroethane; 2-fluoromethoxy-1,1,1,2-tetrafluoroethane; 1-methoxy-1,1,2,2-tetrafluoroethane; 2-methoxy-1,1,1,2-tetrafluoroethane; 1-difluoromethoxy-2,-2-difluoroethane; 2-methoxy-1,1,2-trifluoroethane; 1,1-difluoro-2-methoxyethane; 1,1,2,2-tetrafluoro-3-(trifluoromethoxy)propane; 1-(2,2-difluoroethoxy)-1,1,2,2,2-pentafluoroethane; 3-(difluoromethoxy)-1,1,1,2,2-pentafluoropropane; 1,1,1,3,3,3-hexafluoro-2-(trifluoromethoxy)propane; 1,1,2-trifluoro-1-methoxy-2-(trifluoromethoxy)ethane; 1,1,1,2,3,3-hexafluoro-3-methoxypropane; 1,1,2,2,3,3-hexafluoro-3-methoxypropane; 1-(1,1,-difluoroethoxy)-1,1,2,2-tetrafluoroethane; 3-(difluoromethoxy)-1,1,2,2-tetrafluoropropane; 1,1,1,2,2-pentafluoro-3-methoxypropane; 2-(difluoromethoxy)-1,1,1-trifluoropropane; 2-ethoxy-1,1,1,2-tetrafluoroethane; 1,1,1-trifluoro-2-ethoxyethane; 1,1,1-trifluoro-3-methoxypropane; 1,1,1-trifluoro-2-methoxypropane; 1-ethoxy-1,2,2-trifluoroethane; 1,1,1,2,3,3-hexafluoro-3-(pentafluoroethoxy)propane; 2-ethoxy-1,1,1,2,3,3,3-heptafluoropropane: 3-ethoxy-1,1,1,2,2,3,3-heptafluoropropane; 1-(1,1,2,2-tetrafluoroethoxy)propane; 2,3-difluoro-4-(trifluoromethyl)oxetane; 1-ethoxy-1,1,2,2-tetrafluoroethane; 1,1,1,2,2,3,3-heptafluoro-3-methoxypropane; or a mixture thereof.

13. The electrode of claim 10, wherein the fluorinated or metalloprotein oxygen dissolution enhancer is a fluorinated ester having a general formula of Cₘ₊ₙH₂ₘ₊₁F₂ₙ₊₁C(O)O; wherein n is an integer from 1 to 10 and m is an integer from 1 to 10.

14. The electrode of claim 10, wherein the fluorinated or metalloprotein oxygen dissolution enhancer is a fluorinated carbonate having a general formula of Cₘ₊ₙH₂ₘ₊₁F₂ₙ₊₁CH(CO₃); wherein n is an integer from 1 to 10 and m is an integer from 1 to 10.

15. The electrode of claim 10, wherein the fluorinated carbon material is a solid state material having a general formula of CFₓ; wherein 0.01<x<2.

16. The electrode of claim 10, wherein the fluorinated blood substitute is a fluorocarbon having a general formula CₙFₘ; wherein n is an integer from 1 to 20 and m is an integer from 2 to 42; or the fluorinated blood substitute is a hydrofluorocarbon having a general formula CₙFₚH_{q}; wherein n is an integer from 1 to 20, p is an integer from 2 to 41, and q is an integer from 2 to 41.

17. The electrode of claim 10, wherein the fluorinated blood substitute is perfluorodecalin.

18. The electrode of claim 10, wherein the fluorinated blood substitute is present as an emulsion in the solvent.

19. The electrode of claim 10, wherein the metalloprotein is an ironprotein.

20. The electrode of claim 19, wherein the ironprotein is hemoglobin.

21. The electrode of claim 1, wherein the metal oxide dissolution enhancer comprises an anion receptor; crown ether; cation receptor; a lithium salt dissolved in an organic or inorganic solvent; an ionically conducting polymer; an ionic liquid; a fused lithium salt; a lithium salt dissolved in a linear or cyclic ester, a linear or cyclic ether, acetonitrile, γ-butyrolactone, or a mixture thereof; a lithium salt dissolved in methyl formate, ethylene carbonate, dimethyl carbonate, propylene carbonate, or mixture thereof; a lithium salt dissolved in dimethoxyethane, dioxolanes, or mixture thereof; lithium and a complex anion; LiClO₄, LiBF₄, LiAsF₆, LiSbF₆, LiAlCl₄, LiPF₆, or mixture thereof; LiPF₆ in ethylene carbonate and dimethyl carbonate; LiBF₄ in gamma butyrolactone; LiClO₄ in propylene carbonate; 15-crown-5 ether; NaPF₆ in CH₃CN; propylene carbonate in 12-crown-4 ether; or 1-butyl-3-methylimidazolium hexafluorophosphate; or a mixture thereof.

22. The electrode of claim 1, wherein the current collector comprises porous carbon, a nickel metal grid, a nickel metal mesh, a nickel metal foam, a copper metal grid, a copper metal mesh, a copper metal foam, a titanium metal grid, a titanium metal mesh, a titanium metal foam, a molybdenum metal grid, a molybdenum metal mesh, or a molybdenum metal foam.

23. The electrode of claim 1 further comprising a port in fluid connection with the current collector for providing or removing the solvent, the metal oxide dissolution enhancer, the fluorinated or metalloprotein oxygen dissolution enhancer, or a mixture thereof.

24. The electrode of claim 1, wherein the concentration of the metal oxide dissolution enhancer is greater than 0.01 M.

25. The electrode of claim 1, wherein the concentration of the metal oxide dissolution enhancer is between 0.01 M and 15 M.

26. The electrode of claim 1, wherein the concentration of the fluorinated or metalloprotein oxygen dissolution enhancer is greater than 0.01 M.

27. The electrode of claim 1, wherein the concentration of the fluorinated or metalloprotein oxygen dissolution enhancer is between 0.01 M and 15 M.

28. An electrochemical generator comprising:
a positive electrode comprising:
a solvent having metal ions and oxygen dissolved therein, wherein the metal ions are alkali metal ions, alkali earth metal ions, or lanthanide metal ions;
a fluorinated or metalloprotein oxygen dissolution enhancer provided in the solvent for enhancing dissolution of the oxygen in the solvent;
a metal oxide dissolution enhancer provided in the solvent, the metal oxide dissolution enhancer for enhancing dissolution of metal oxide formed via reaction of the oxygen with the metal ions in the solvent;
a current collector provided in electrical contact with the solvent;
a negative electrode comprising an active negative electrode material; and
a separator provided between the negative electrode and the positive electrode, wherein the separator conducts metal ions as a charge carrier in the electrochemical generator.

29. The electrochemical generator of claim 28, wherein during discharge of the electrochemical generator, the metal ions are released from the negative electrode and stored by the positive electrode; and wherein during charging of the electrochemical generator, the metal ions are released from the positive electrode and stored by the negative electrode.

30. An electrochemical generator comprising:
a positive electrode comprising:
a first solvent having electron donor metal ions and oxygen dissolved therein, wherein the electron donor metal ions are alkali metal ions, alkali earth metal ions, lanthanide metal ions, or a mixture thereof;
a fluorinated or metalloprotein oxygen dissolution enhancer provided in the first solvent for enhancing dissolution of the oxygen in the first solvent;
a metal oxide dissolution enhancer provided in the first solvent, the metal oxide dissolution enhancer for enhancing dissolution of electron donor metal oxide formed via reaction of the oxygen with the electron donor metal ions in the first solvent;
a current collector provided in electrical contact with the first solvent;
a negative soluble electrode comprising:
an electron donor comprising an electron donor metal provided in a second solvent, wherein the electron donor metal is an alkali metal, an alkali earth metal, a lanthanide metal or alloy thereof;
an electron acceptor provided in the second solvent, wherein the electron acceptor is a polycyclic aromatic hydrocarbon or an organo radical;
a supporting electrolyte comprising a metal at least partially dissolved in the second solvent;
a current collector provided in contact with the second solvent;
wherein at least a portion of the electron donor comprising an electron donor metal is dissolved in the second solvent, thereby generating electron donor metal ions and solvated electrons in the second solvent; and
a separator provided between the negative soluble electrode and the positive electrode, wherein the separator is non-liquid and conducts the electron donor metal ions as a charge carrier in the electrochemical generator.

31. An electrochemical generator comprising:
a positive electrode comprising:
a first solvent having metal ions and oxygen dissolved therein, wherein the metal ions are lithium ions;
a fluorinated or metalloprotein oxygen dissolution enhancer provided in the first solvent for enhancing dissolution of the oxygen in the first solvent;
a metal oxide dissolution enhancer provided in the first solvent, the metal oxide dissolution enhancer for enhancing dissolution of lithium oxide formed via reaction of the oxygen with the lithium ions in the first solvent;
a current collector provided in electrical contact with the first solvent;
a negative soluble electrode comprising:
an electron donor comprising an electron donor metal provided in a second solvent, wherein the electron donor metal is lithium;
an electron acceptor provided in the second solvent, wherein the electron acceptor is a polycyclic aromatic hydrocarbon;
a supporting electrolyte comprising a metal at least partially dissolved in the second solvent;
a current collector provided in contact with the second solvent;
wherein at least a portion of the electron donor comprising an electron donor metal is dissolved in the second solvent, thereby generating lithium ions and solvated electrons in the second solvent; and
a separator provided between the negative soluble electrode and the positive electrode, wherein the separator is non-liquid and conducts the lithium ions as a charge carrier in the electrochemical generator.

32. An electrochemical generator comprising:
a positive electrode comprising:
a first solvent having metal ions and oxygen dissolved therein, wherein the metal ions are sodium ions;
a fluorinated or metalloprotein oxygen dissolution enhancer provided in the first solvent for enhancing dissolution of the oxygen in the first solvent;
a metal oxide dissolution enhancer provided in the first solvent, the metal oxide dissolution enhancer for enhancing dissolution of sodium oxide formed via reaction of the oxygen with the sodium ions in the first solvent;
a current collector provided in electrical contact with the first solvent;
a negative soluble electrode comprising:
an electron donor comprising an electron donor metal provided in a second solvent, wherein the electron donor metal is sodium;
an electron acceptor provided in the second solvent, wherein the electron acceptor is a polycyclic aromatic hydrocarbon;
a supporting electrolyte comprising a metal at least partially dissolved in the second solvent;
a current collector provided in contact with the second solvent;
wherein at least a portion of the electron donor comprising an electron donor metal is dissolved in the second solvent, thereby generating sodium ions and solvated electrons in the second solvent; and
a separator provided between the negative soluble electrode and the positive electrode, wherein the separator is non-liquid and conducts the sodium ions as a charge carrier in the electrochemical generator.

33. An electrochemical generator comprising:
a positive electrode comprising:
a first solvent having electron donor metal ions and oxygen dissolved therein, wherein the electron donor metal ions are alkali metal ions, alkali earth metal ions, lanthanide metal ions, or a mixture thereof;
a fluorinated or metalloprotein oxygen dissolution enhancer provided in the first solvent for enhancing dissolution of the oxygen in the first solvent; wherein the fluorinated or metalloprotein oxygen dissolution enhancer is a fluorinated ether, a fluorinated ester, a fluorinated carbonate, a fluorinated polymer, or mixture thereof;
a metal oxide dissolution enhancer provided in the first solvent, the metal oxide dissolution enhancer for enhancing dissolution of electron donor metal oxide formed via reaction of the oxygen with the electron donor metal ions in the first solvent;
a current collector provided in electrical contact with the first solvent;
a negative soluble electrode comprising:
an electron donor comprising an electron donor metal provided in a second solvent, wherein the electron donor metal is an alkali metal, an alkali earth metal, a lanthanide metal or alloy thereof;
an electron acceptor provided in the second solvent, wherein the electron acceptor is a polycyclic aromatic hydrocarbon or an organo radical;
a supporting electrolyte comprising a metal at least partially dissolved in the second solvent;
a current collector provided in contact with the second solvent;
wherein at least a portion of the electron donor comprising an electron donor metal is dissolved in the second solvent, thereby generating electron donor metal ions and solvated electrons in the second solvent; and
a separator provided between the negative soluble electrode and the positive electrode, wherein the separator is non-liquid and conducts the electron donor metal ions as a charge carrier in the electrochemical generator.

34. A method of generating an electrical current, the method comprising:
providing an electrochemical generator, the generator comprising:
a positive electrode comprising:
a first solvent having metal ions and oxygen dissolved therein, wherein the metal ions are alkali metal ions, alkali earth metal ions, or lanthanide metal ions;
a fluorinated or metalloprotein oxygen dissolution enhancer provided in the first solvent for enhancing dissolution of the oxygen in the first solvent;
a metal oxide dissolution enhancer provided in the first solvent, the metal oxide dissolution enhancer for enhancing dissolution of metal oxide formed via reaction of the oxygen with the metal ions in the first solvent;
a current collector provided in electrical contact with the first solvent;
a negative soluble electrode comprising:
an electron donor comprising an electron donor metal provided in a second solvent, wherein the electron donor metal is an alkali metal, an alkali earth metal, a lanthanide metal or alloy thereof;
an electron acceptor provided in the second solvent, wherein the electron acceptor is a polycyclic aromatic hydrocarbon or an organo radical;
a supporting electrolyte comprising a metal at least partially dissolved in the second solvent;
a current collector provided in contact with the second solvent;
wherein at least a portion of the electron donor comprising an electron donor metal is dissolved in the second solvent, thereby generating electron donor metal ions and solvated electrons in the second solvent;
a separator provided between the negative soluble electrode and the positive electrode, wherein the separator is non-liquid and conducts the electron donor metal ions as a charge carrier in the electrochemical generator; and
discharging the electrochemical generator.

35. A method of charging an electrochemical generator, the method comprising:
providing an electrochemical generator, the generator comprising:
a positive electrode comprising:
a first solvent having metal ions and oxygen dissolved therein, wherein the metal ions are alkali metal ions, alkali earth metal ions, or lanthanide metal ions;
a fluorinated or metalloprotein oxygen dissolution enhancer provided in the first solvent for enhancing dissolution of the oxygen in the first solvent;
a metal oxide dissolution enhancer provided in the first solvent, the metal oxide dissolution enhancer for enhancing dissolution of metal oxide formed via reaction of the oxygen with the metal ions in the first solvent;
a current collector provided in electrical contact with the first solvent;
a negative soluble electrode comprising:
an electron donor comprising an electron donor metal provided in a second solvent, wherein the electron donor metal is an alkali metal, an alkali earth metal, a lanthanide metal or alloy thereof;
an electron acceptor provided in the second solvent, wherein the electron acceptor is a polycyclic aromatic hydrocarbon or an organo radical;
a supporting electrolyte comprising a metal at least partially dissolved in the second solvent;
a current collector provided in contact with the second solvent;
wherein at least a portion of the electron donor comprising an electron donor metal is dissolved in the second solvent, thereby generating electron donor metal ions and solvated electrons in the second solvent;
a separator provided between the negative soluble electrode and the positive electrode, wherein the separator is non-liquid and conducts the electron donor metal ions as a charge carrier in the electrochemical generator;
selecting a charging voltage and/or current for charging the electrochemical generator; and
providing the selected voltage and/or current to the electrodes of the electrochemical generator to charge the electrochemical generator.

36. The method of claim 35, wherein the voltage and/or current provided to the electrochemical generator is preselected according to the number of charge/discharges cycles the electrochemical generator has experienced.

37. A method of discharging and refueling an electrochemical generator, the method comprising:
providing an electrochemical generator, the generator comprising:
a positive electrode comprising:
a first solvent having metal ions and oxygen dissolved therein, wherein the metal ions are alkali metal ions, alkali earth metal ions, or lanthanide metal ions;
a fluorinated or metalloprotein oxygen dissolution enhancer provided in the first solvent for enhancing dissolution of the oxygen in the first solvent;
a metal oxide dissolution enhancer provided in the first solvent, the metal oxide dissolution enhancer for enhancing dissolution of metal oxide formed via reaction of the oxygen with the metal ions in the first solvent;
a current collector provided in electrical contact with the first solvent;
a negative soluble electrode comprising:
an electron donor comprising an electron donor metal provided in a second solvent, wherein the electron donor metal is an alkali metal, an alkali earth metal, a lanthanide metal or alloy thereof;
an electron acceptor provided in the second solvent, wherein the electron acceptor is a polycyclic aromatic hydrocarbon or an organo radical;
a supporting electrolyte comprising a metal at least partially dissolved in the second solvent;
a current collector provided in contact with the second solvent;
wherein at least a portion of the electron donor comprising an electron donor metal is dissolved in the second solvent, thereby generating electron donor metal ions and solvated electrons in the second solvent;
a separator provided between the negative soluble electrode and the positive electrode, wherein the separator is non-liquid and conducts the electron donor metal ions as a charge carrier in the electrochemical generator;
discharging the electrochemical generator, thereby generating a discharged electrochemical generator;
removing substantially all of the electron donor metal, electron acceptor and second solvent from the soluble negative electrode from the discharged electrochemical generator;
providing electron donor metal, electron acceptor and second solvent to the soluble negative electrode to the discharged electrochemical generator;
removing substantially all of the first solvent, fluorinated or metalloprotein oxygen dissolution enhancer, and metal oxide dissolution enhancer from the positive electrode from the discharged electrochemical generator; and
providing first solvent, fluorinated or metalloprotein oxygen dissolution enhancer, and metal oxide dissolution enhancer to the positive electrode to the discharged electrochemical generator;
thereby refueling the electrochemical generator.
